(19) United States
(12) Patent Application Publication
(10) Pub. No.: US 2026/0162211 A1
(43) Pub. Date: Jun. 11, 2026

(54) PROCESSOR PROVIDING DATA DUPLICATION, OPERATION METHOD THEREOF, AND SYSTEM-ON-CHIP INCLUDING THE SAME

(71) Applicant: Samsung Electronics Co., Ltd., Suwon-si (KR)

(72) Inventors: Seunghun Kim, Suwon-si (KR); Jun Hee Yoo, Suwon-si (KR)

(73) Assignee: Samsung Electronics Co., Ltd., Suwon-si (KR)

(21) Appl. No.: 19/337,083

(22) Filed: Sep. 23, 2025

(30) Foreign Application Priority Data
Dec. 11, 2024 (KR) 10-2024-0183944

(51) Int. Cl. G06T 1/60; G06T 11/40

(52) U.S. Cl. CPC G06T 1/60; G06T 11/40

(57) ABSTRACT

A method of operating a system-on-chip includes generating a first converted image tile based on a first image tile and a second image tile disposed adjacent to the first image tile, the first image tile including a plurality of first pixel data, the second image tile including a plurality of second pixel data, and the first converted image tile including the plurality of first pixel data and at least one second adjacent pixel data; generating a second converted image tile, based on the first image tile and the second image tile, wherein the second converted image tile includes the plurality of second pixel data and at least one first adjacent pixel data; storing the first converted image tile and the second converted image tile in a memory hierarchy; and performing kernel processing based on the first converted image tile and the second converted image tile.

### CROSS-REFERENCE TO RELATED APPLICATION

This application claims priority under 35 U.S.C. § 119 to Korean Patent Application No. 10-2024-0183944 filed on Dec. 11, 2024, in the Korean Intellectual Property Office, the disclosure of which is incorporated by reference herein in its entirety.

### BACKGROUND

Embodiments of the present disclosure described herein relate to semiconductor devices, and more particularly, relate to a processor providing data duplication, an operation method thereof, and a system-on-chip including the same.

IP blocks and processors included in a system-on-chip may include a local cache that stores data required for an operation. The system-on-chip may have a global cache that is jointly accessible through a bus. The local cache and the global cache may have a hierarchical structure, and each may load data or store data according to a predetermined alignment rule.

A processor that provides image processing, etc. may perform kernel processing on data included in an image. The processor may load an image tile into the local cache for kernel processing. When the processor performs kernel processing on the boundary of an image tile, data from an adjacent image tile may be required, and cache misses or data movement overhead may occur.

### SUMMARY

Embodiments of the present disclosure provide a data storage method or a data conversion method of a processor that enables the processor performing kernel processing to reduce a cache miss ratio and to perform efficient kernel processing or kernel operations.

According to an embodiment of the present disclosure, a method of operating a system-on-chip includes generating a first converted image tile corresponding to a first image tile, based on the first image tile and a second image tile disposed adjacent to the first image tile, the first image tile and the second image tile selected from a plurality of image tiles included in image data, wherein the first image tile includes a plurality of first pixel data, the second image tile includes a plurality of second pixel data, and the first converted image tile includes the plurality of first pixel data and at least one second adjacent pixel data disposed adjacent to the first image tile, the at least one second adjacent pixel data selected from the plurality of second pixel data; generating a second converted image tile corresponding to the second image tile, based on the first image tile and the second image tile, wherein the second converted image tile includes the plurality of second pixel data and at least one first adjacent pixel data disposed adjacent to the second image tile, the at least one first adjacent pixel data selected from the plurality of first pixel data; storing the first converted image tile in a memory hierarchy, wherein the memory hierarchy includes a local cache, a system cache, a host memory, and a storage device; storing the second converted image tile in the memory hierarchy; and performing kernel processing based on the first converted image tile and the second converted image tile.

According to an embodiment of the present disclosure, a processor configured for kernel processing and data conversion of image tiles includes a processing block, a data conversion block, and a bus interface block. The processing block is configured to perform the kernel processing and control the processor. The data conversion block is configured to control the data conversion and an input/output of the processor. The bus interface block is configured to perform the input/output of the processor. The image tiles include a first image tile including a plurality of first pixel data and a second image tile disposed adjacent to the first image tile and including a plurality of second pixel data. The processor is configured to perform the data conversion to generate a first converted image tile corresponding to the first image tile and a second converted image tile corresponding to the second image tile. The first converted image tile includes the plurality of first pixel data and at least one second adjacent pixel data disposed adjacent to the first image tile, the at least one second adjacent pixel data selected from the plurality of second pixel data. The second converted image tile includes the plurality of second pixel data and at least one first adjacent pixel data disposed adjacent to the second image tile, the at least one first adjacent pixel data selected from the plurality of first pixel data.

According to an embodiment of the present disclosure, a system-on-chip includes a main processor, a first processor, and a system cache. The main processor is configured to control an operation of the system-on-chip. The first processor is configured to perform kernel processing and data conversion of image tiles. The system cache is configured to store data of the system-on-chip. The image tiles include a first image tile and a second image tile disposed adjacent to the first image tile. The first processor is configured to generate a plurality of converted image tiles including a first converted image tile corresponding to the first image tile and a second converted image tile corresponding to the second image tile. The first converted image tile includes the plurality of first pixel data and at least one second adjacent pixel data disposed adjacent to the first image tile, the at least one second adjacent pixel data selected from the plurality of second pixel data. The second converted image tile includes the second plurality of pixel data and at least one first adjacent pixel data disposed adjacent to the second image tile, the at least one first adjacent pixel data selected from the plurality of first pixel data.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a system-on-chip, according to an embodiment of the present disclosure.

FIG. 2 is a block diagram illustrating an example of a memory hierarchy of an electronic device including a system-on-chip of FIG. 1, according to an embodiment of the present disclosure.

FIG. 3 is a diagram illustrating an example of kernel processing of image tiles, according to an embodiment of the present disclosure.

FIG. 4 is a diagram illustrating an example of converted image tiles, according to an embodiment of the present disclosure.

FIG. 5 is a flowchart illustrating an example of an operation method of a second processor of FIG. 1, according to an embodiment of the present disclosure.

FIG. 6 is a block diagram illustrating in detail a second processor of FIG. 1, according to an embodiment of the present disclosure.

FIG. 7 is a diagram illustrating an example of converted image tiles, according to an embodiment of the present disclosure.

FIG. 8A is a flowchart illustrating how a bus interface block of FIG. 6 generates a row of converted image tiles from a row of image data, according to an embodiment of the present disclosure.

FIG. 8B is a diagram illustrating one row of converted image tiles generated by a method of FIG. 8A, according to an embodiment of the present disclosure.

FIG. 9 is a flowchart illustrating how a bus interface block of FIG. 6 generates a row of converted image tiles from a row of image data, according to an embodiment of the present disclosure.

FIG. 10 is a flowchart illustrating an example of how a second processor of FIG. 6 generates converted image tiles of image data, according to an embodiment of the present disclosure.

FIG. 11 is a flowchart illustrating an example of how a second processor of FIG. 6 generates converted image tiles of image data, according to an embodiment of the present disclosure.

FIG. 12 is a flowchart illustrating an example of how a second processor of FIG. 6 converts converted image tiles into image tiles, according to an embodiment of the present disclosure.

FIG. 13 is a block diagram illustrating a system-on-chip, according to an embodiment of the present disclosure.

FIG. 14 is a flowchart illustrating an example of an operation method of a system-on-chip of FIG. 13, according to an embodiment of the present disclosure.

FIG. 15 is a block diagram illustrating an electronic device, according to an embodiment of the present disclosure.

FIG. 16 is a block diagram illustrating an electronic device, according to an embodiment of the present disclosure.

### DETAILED DESCRIPTION

Components that are described with reference to terms such as “˜unit,” “module,” “block,” “˜er or ˜or,” “circuit,” “circuitry,” etc. used throughout the detailed description, and function blocks illustrated in the drawings may be implemented with software, hardware, or a combination thereof. In some embodiments, the software may be or include machine code, firmware, embedded code, source code, application software, and/or combinations thereof. In some embodiments, the hardware may be or include an electrical circuit, an electronic circuit (an analog circuit or a digital circuit), a processor, a computer, an integrated circuit, integrated circuit cores, a pressure sensor, an inertial sensor, a microelectromechanical system (MEMS), a passive element, and/or combinations thereof.

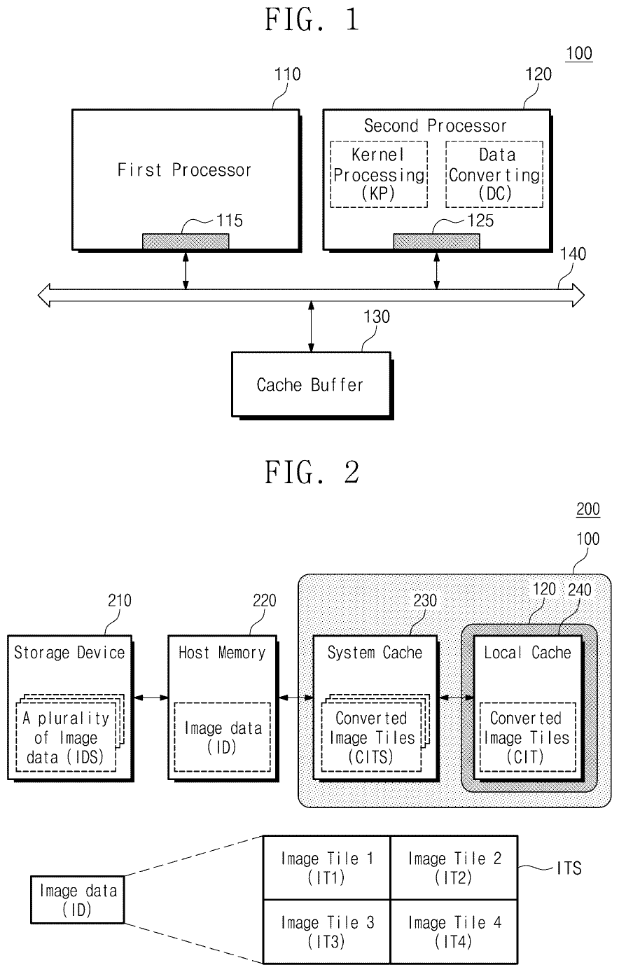

FIG. 1 is a block diagram illustrating a system-on-chip, according to an embodiment of the present disclosure. Referring to FIG. 1, a system-on-chip 100 may include a first processor 110, a second processor 120, a cache buffer 130, and a bus 140. In some embodiments, the system-on-chip 100 may be included in an electronic device. For example, the system-on-chip 100 may be included in various electronic devices such as a personal computer (PC), a tablet PC, a smartphone, a server, a datacenter, an IoT device (internet of things device), an automotive system, or a wearable device. In some embodiments, the system-on-chip 100 may control the electronic device or may perform operations necessary for the operation of the electronic device.

The processors 110 and 120 may control the operation of the system-on-chip or may perform operations. In some embodiments, the processors 110 and 120 may be various processing units or may include various processing units. For example, each of the processors 110 and 120 may be or include a single core or multi-core CPU (central processing unit), a GPU (graphics processing unit), an NPU (neural processing unit), a TPU (tensor processing unit), an NP (neuromorphic processor), or a combination thereof. For a more detailed example, the first processor 110 may be a general-purpose processor such as a CPU, and the second processor 120 may be a special-purpose processor such as an NPU.

In some embodiments, the processors 110 and 120 may include a local cache. In some embodiments, the processors 110 and 120 may include registers that may temporarily store data or instructions necessary for an operation. For example, each of the processors 110 and 120 may include local caches or registers that store instructions indicating an operation to be performed or data necessary for an operation. In some embodiments, the local cache may be or include a volatile memory device such as a static random access memory (SRAM).

In some embodiments, one of the processors 110 and 120 may be a main processor. For example, the first processor 110 may be a main processor and may control overall operations of the system-on-chip. In some embodiments, the first processor 110 may control overall operations of the system-on-chip 100, may schedule operations to be performed by the system-on-chip 100, or may determine a subject (e.g., the first processor 110 or the second processor 120) to perform the operations and may distribute the operations. In some embodiments, one of the processors 110 and 120 may be a special purpose processor or a specialized processor. For example, the second processor 120 may be a processor specialized in image processing, machine learning, graphics operations, etc. In some embodiments, the second processor 120 may operate under the control of the first processor 110.

The second processor 120 may provide kernel processing KP. In some embodiments, the second processor 120 may perform operations for the kernel processing KP on an image file. For example, the second processor 120 may perform operations such as filtering on an image file based on operations for the kernel processing KP, and may provide various processing of the image file.

In some embodiments, the second processor 120 may store some of the image files (e.g., image tiles) in a local cache. In some embodiments, the second processor 120 may access some of the image files stored in the local cache, and may perform the kernel processing KP on some of the image files.

In some embodiments, when the second processor 120 performs the kernel processing KP on a first portion of the image file, at least some of other portions of the image file may be required for the operation. The second processor 120 may perform data conversion DC to generate conversion data including all data required for the kernel processing KP of the target of the kernel processing KP. For example, the second processor 120 may provide the data conversion DC to generate a converted image tile including all data required for the image tile on which the kernel processing KP is performed.

In some embodiments, the second processor 120 may access the converted data and may perform the kernel processing KP based on the converted data. The second processor 120 may reduce or eliminate cache misses occurring during the operation of the kernel processing KP based on the data conversion DC and may improve the speed of processing. The kernel processing KP and the data conversion DC of the second processor 120 will be described in more detail with reference to FIGS. 2 to 12.

The processors 110 and 120 may each include bus interfaces 115 and 125 for communication. For example, the processors 110 and 120 may be connected to or communicate with the bus 140 through the bus interfaces 115 and 125. In some embodiments, the bus interfaces 115 and 125 may perform communication with the bus 140 according to one of various standards or conventions. In some embodiments, the bus interfaces 115 and 125 may capture at least some or all of the data being transmitted and received.

The cache buffer 130 may store data necessary for the operation of the system-on-chip 100. The cache buffer 130 may operate as a system cache of the system-on-Attorney chip 100. In some embodiments, the cache buffer 130 may store instructions indicating operations of the system-on-chip 100 or data used for the operations of the system-on-chip 100. For example, the cache buffer 130 may store instructions indicating the operations to be performed by the processors 110 and 120. For example, the cache buffer 130 may store data required for the operations of the processors 110 and 120.

In some embodiments, the cache buffer 130 may operate as a global cache of the system-on-chip 100. For example, the cache buffer 130 may have a hierarchical structure with the local caches within the processors 110 and 120 and may be accessed by all of the processors 110 and 120. In some embodiments, the cache buffer 130 may be a volatile memory device such as an SRAM or may include a volatile memory device. The cache buffer 130 may send data or receive data to be stored through the bus 140.

The bus 140 may provide communication within the system-on-chip 100. In some embodiments, the bus 140 may provide communication between the first processor 110, the second processor 120, and the cache buffer 130. In some embodiments, the bus 140 may provide communication between components within the system-on-chip 100 based on one of various standards or conventions.

The components included in the system-on-chip 100 illustrated in FIG. 1 are an example and may further include additional components. For example, the system-on-chip 100 may further include an interface for exchanging data with a solid state drive (SSD) device included in an electronic device including the system-on-chip 100 or a host memory (e.g., a DRAM device, etc.) of the electronic device. For another example, the system-on-chip 100 may further include an interface for connecting with one or more devices that receive input from a user or send output to a user. It should also be understood that embodiments in which the system-on-chip 100 does not include at least some of the blocks are also within the scope of the present disclosure. It should also be understood that embodiments in which the bus 140 includes the cache buffer 130 (e.g., embodiments in which the cache buffer 130 and the bus 140 are implemented as a single network-on-chip (NOC)) are also within the scope of the present disclosure.

Hereinafter, the description will be made based on that the system-on-chip 100 performs image processing, but this is an example and the scope of the present disclosure should not be limited thereto. It should be understood that the technical idea of the present disclosure described throughout this specification may be applied equally or similarly to various fields that apply or use kernel processing, such as artificial intelligence models such as a CNN (convolutional neural network) or image processing.

FIG. 2 is a block diagram illustrating an example of a memory hierarchy of an electronic device including a system-on-chip of FIG. 1, according to an embodiment of the present disclosure. Referring to FIG. 2, a memory hierarchy 200 may include a storage device (e.g., a solid state drive) 210, a host memory 220, a system cache 230, and a local cache 240. The memory hierarchy 200 of an electronic device including the system-on-chip 100 of FIG. 1, according to an embodiment of the present disclosure is described with reference to FIGS. 1 and 2.

The storage device 210 may store data of the electronic device for a long period of time. In some embodiments, the storage device 210 may include nonvolatile memory device(s) such as a NAND flash memory. In some embodiments, the storage device 210 may form the lowest level of the memory hierarchy 200. In some embodiments, the storage device 210 may store a large amount of data. For example, the storage device 210 may store a plurality of image data IDS.

In some embodiments, the storage device 210 may be a device connected to a host including the host memory 220 and the system-on-chip 100. In some embodiments, the storage device 210 may store data necessary for the operation of the host connected to an SSD. For example, the storage device 210 may store operation data (e.g., filter data) necessary for image processing of the host or weight data for implementing a neural network model.

The host memory 220 may store data necessary for the operation of the host. In some embodiments, the host memory 220 may be included in a host including the system-on-chip 100. In some embodiments, the host memory 220 may store some of the plurality of image data IDS. For example, the host memory 220 may store one piece of image data ID among the plurality of image data IDS. Although the host memory 220 is described based on storing one piece of the image data ID, this is an example and the present disclosure is not limited thereto. The policy for storing the image data ID by the host memory 220 is an example and the scope of the present disclosure is not limited thereto.

The host memory 220 may have a higher level than the storage device 210 within the memory hierarchy 200. In some embodiments, the host memory 220 may include a volatile memory device or may be implemented as a volatile memory device. For example, the host memory 220 may be a DRAM device or may include the DRAM device.

The image data ID may include at least one image tile. Each of image tiles ITS may be a part of the image data ID. In some embodiments, the image data ID may include image tiles of the same size. For example, referring to FIG. 2, the image data ID may include four image tiles IT1 to IT4, and the sizes of each of the image tiles IT1 to IT4 may be the same. In some embodiments, the sizes of at least some of the image tiles IT1 to IT4 may be different from other parts of the image tiles.

In some embodiments, the sizes of each of the image tiles may be determined in advance. For example, the sizes of each of the image tiles may be determined in advance depending on firmware or an application programming interface (API). For another example, the sizes of each of the image tiles may be determined in advance depending on an operating system, the size of a cache area space, or a setting of software (or a program). In FIG. 2, the image data ID is described based on including four image tiles ITS of the same size, but the scope of the present disclosure is not limited thereto. It should be understood that an embodiment in which the image data ID includes any number of image tiles (for example, in any arrangement) is also within the scope of the present disclosure.

The system cache 230 may be included in the system-on-chip 100 and may store data required for the operation of the system-on-chip 100. The system cache 230 may correspond to the cache buffer 130 of FIG. 1 or may be identical or similar to the cache buffer 130. The system cache 230 may store a plurality of converted image tiles CITS.

Each of the converted image tiles CITS may include pixel data required for the kernel processing KP of the corresponding image tiles ITS. In some embodiments, each of the converted image tiles CITS may include all of the pixel data used for the kernel processing KP of the corresponding image tiles ITS. For example, a converted image tile CIT may include pixel data of the corresponding image tile IT and pixel data of image tiles adjacent to the image tile IT. The converted image tiles CITS will be described in more detail with reference to FIGS. 4 and 7. In some embodiments, the second processor 120 may load the converted image tile CIT and may perform the kernel processing KP on the corresponding image tile IT without a cache miss.

In some embodiments, the image tile IT of the host memory 220 may be converted into the converted image tile CIT and may be loaded into the system cache 230. For example, the image tile IT of the host memory 220 may be converted into the converted image tile CIT by the system-on-chip 100 and may be stored in the system cache 230. The converted image tiles CITS stored in the system cache 230 may be accessed by the second processor 120.

In some embodiments, the system cache 230 may load or store some of the converted image tiles of the image data ID. In some embodiments, the system cache 230 may operate as a global cache of the system-on-chip 100 and may store instructions or data necessary for the operation of the system-on-chip 100. The second processor 120 may perform the kernel processing KP of the image tiles (for example, without a cache miss) through the converted image tiles stored in the system cache 230. The system cache 230 may have a higher level than the host memory 220 within the memory hierarchy 200.

The local cache 240 may be included in the second processor 120 and may store data necessary for the operation of the second processor 120. In some embodiments, the local cache 240 may store one image tile IT. In some embodiments, the local cache 240 may further store instructions to be executed by the second processor 120 or operation data (e.g., filter values or weights, etc.) used for the kernel processing KP. For example, the local cache 240 may store the image tile IT and the instruction(s) pointing to the kernel processing KP with respect to the image tile.

The local cache 240 may have the highest level in the memory hierarchy 200 and may be directly accessed by the second processor 120. In some embodiments, the local cache 240 may include or may be implemented as a volatile memory device. For example, the local cache 240 may be implemented as an SRAM. In FIG. 2, the second processor 120 is described based on including the local cache 240, but the first processor 110 may also include a local cache that is the same as or similar to the local cache 240.

In FIG. 2, when the image tiles ITS are transferred from the host memory 220 to the system cache 230, the image tiles ITS are converted into the converted image tiles CITS, but this is an example and the scope of the present disclosure is not limited thereto. It should be understood that an embodiment in which the image tiles ITS are converted and transferred from the storage device 210 to the host memory 220 is also within the scope of the present disclosure. For example, the image tiles ITS of the image data ID of the storage device 210 may be converted and transferred to the host memory 220, and the host memory 220 may store converted image data including the plurality of converted image tiles CITS. It should be understood that an embodiment in which the system cache 230 stores image tiles and the local cache 240 converts and loads one converted image tile is also within the scope of the present disclosure. In some embodiments, the generation or conversion of the converted image tile CIT from the image tile IT may be performed based on interface operations between the storage device 210, the host memory 220, the system cache 230, or the local cache 240.

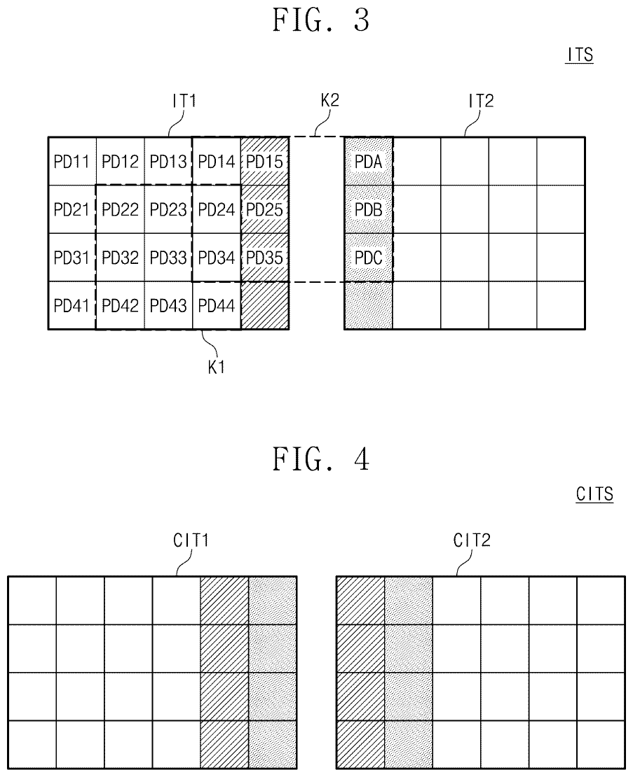

FIG. 3 is a diagram illustrating an example of kernel processing of image tiles, according to an embodiment of the present disclosure. Referring to FIGS. 1 to 3, the kernel processing for the image tiles ITS, according to an embodiment of the present disclosure is described.

The image tiles may include a plurality of pixel data. In some embodiments, the pixel data may include information associated with one pixel. In some embodiments, the pixel data may include information associated with a plurality of pixels. For example, the pixel data may include data associated with the color of one pixel, or the pixel data may include data associated with the color of each of nine pixels in a three-row, three-column arrangement.

The number of pixels included in the pixel data or the arrangement of the pixels is an example and the scope of the present disclosure is not limited thereto. It should be understood that an embodiment in which the pixel data includes information associated with any number of pixels in any arrangement is also within the scope of the present disclosure.

In some embodiments, the pixel data may be a reference for the kernel processing KP. FIG. 3 illustrates that the image tiles IT1 and IT2 each include 20 pixel data in four rows and five columns, but this is an example and the scope of the present disclosure is not limited thereto. That is, each of the image tiles IT1 and IT2 may include pixel data of an array of “m” rows and “n” columns. Hereinafter, the expression “m×n” may refer to “m” rows and “n” columns.

In some embodiments, the kernel processing KP may be performed on the central pixel data and the pixel data surrounding the central pixel data. Referring to a first kernel K1, the kernel processing KP may be performed on nine pixel data, and the generated result value may be assigned to the pixel data of the center of the first kernel K1. That is, the first kernel K1 may perform kernel processing on pixel data PD22, PD23, PD24, PD32, PD33, PD34, PD42, PD43, and PD44, and the result may be an output corresponding to the 33rd pixel data PD33. For the second kernel K2, kernel processing may be performed on nine pixel data PD14, PD15, PD24, PD25, PD34, PD35, PDA, PDB, and PDC as well as for the first kernel K1.

In some embodiments, the image tiles IT1 and IT2 may be loaded or stored in the local cache 240 according to a cache alignment rule. For example, when the first image tile IT1 is loaded in the local cache 240, the second image tile IT2 may not be loaded in the local cache 240 according to the cache alignment rule. For another example, the local cache 240 may not load a part of the first image tile IT1 and a part of the second image tile IT2 according to the cache alignment rule.

Referring to the second kernel K2, center pixel data PD25 may be pixel data forming the boundary surface of the first image tile IT1. In this case, the kernel processing KP of the second kernel K2 may request the pixel data PDA, PDB, and PDC of the second image tile IT2. In the kernel processing KP of the second kernel K2, the second processor 120 may not load some or all of the image tiles IT1 and IT2 into the local cache 240 at the same time according to the cache alignment rule, and thus, a cache miss may occur.

Therefore, when the second processor 120 performs the kernel processing KP of the second kernel K2 and the first image tile IT1 is loaded into the local cache 240, a cache hit may occur with respect to six pixel data PD14, PD15, PD24, PD25, PD34, and PD35, but a cache miss may occur with respect to the pixel data PDA, PDB, and PDC of the second image tile IT2. To eliminate or reduce the overhead caused by such cache miss, the second processor 120 may generate a converted image tile based on the data conversion DC of the image tile IT. An example of a converted image tile generated by the second processor 120 will be described in more detail with reference to FIG. 4.

FIG. 4 is a diagram illustrating converted image tiles, according to an embodiment of the present disclosure. Referring to FIG. 4, the converted image tiles CITS may include a first converted image tile CIT1 and a second converted image tile CIT2.

In some embodiments, each of the converted image tiles CITS may include one or more pixel data forming a boundary between image tiles of adjacent image tiles. For example, the first converted image tile CIT1 may include one or more pixel data forming a boundary of the second image tile IT2 on the right side of the first converted image tile CIT1. In another example, the second converted image tile CIT2 may include one or more pixel data forming a boundary of the first image tile IT1 on the left side of the second converted image tile CIT2.

In some embodiments, the second processor 120 may load or store one of the converted image tiles CITS in the local cache 240 of FIG. 2 according to the cache alignment rule. For example, the second processor 120 may load or store the first converted image tile CIT1 in the local cache 240 and may perform the kernel processing KP of the first image tile IT1 (e.g., without the cache miss). As in the above description, for another example, the second processor 120 may load or store the second converted image tile CIT2 in the local cache 240 and may perform the kernel processing KP of the second image tile IT2 (e.g., without the cache miss). The second processor 120 may eliminate or reduce cache misses based on the operation of generating the converted image tiles CITS from each of the image tiles ITS.

In some embodiments, the number of pixel data included in the converted image tiles may vary depending on the position of the image tiles or the size of the kernel of the kernel processing KP. For example, when the kernel corresponds to a 3×3 array of pixel data and the image tiles include pixel data in an “m×n” array, the converted image tiles may include pixel data in an (m+1)×(n+1) array, or pixel data in an (m+2)×(n+1) array, or pixel data in an (m+1)×(n+2) array, or pixel data in an (m+2)×(n+2) array. For another example, when the kernel corresponds to a 5×5 array of pixel data and the image tiles include pixel data in an “m”×“n” array, the converted image tiles may include pixel data in an (m+2)×(n+2) array, pixel data in an (m+4)×(n+2) array, pixel data in an (m+2)×(n+4) array, or pixel data in an (m+4)×(n+4) array.

The size of the kernel or the number and arrangements of pixel data included in the image tiles are an example and the present disclosure is not limited thereto. In some embodiments, the number and arrangement of pixel data included in the converted image tiles may be the same. For example, when the kernel size corresponds to a 3×3 array of pixel data and the image tiles include an “m” x “n” array of pixel data, the converted image tiles may all include pixel data in an (m+2)×(n+2) array. In this case, the converted image tiles of the image tiles corresponding to the image tiles forming the boundary of the image data ID may include pixel data padded with “0” on the outside of the portion forming the boundary of the image data, and the converted image tiles may all include pixel data in an (m+2)×(n+2) array.

In FIG. 4, the description is performed based on that the converted image tiles are generated based on the pixel data that forms the column-direction boundary, but the scope of the present disclosure is not limited thereto. For example, in FIGS. 3 and 4, an embodiment in which the first converted image tile CIT1 includes image tiles forming the upper boundary of the third image tile should also be understood to fall within the scope of the present disclosure. The converted image tiles whose kernel sizes are different from the example in FIG. 4 are described in more detail through FIG. 7.

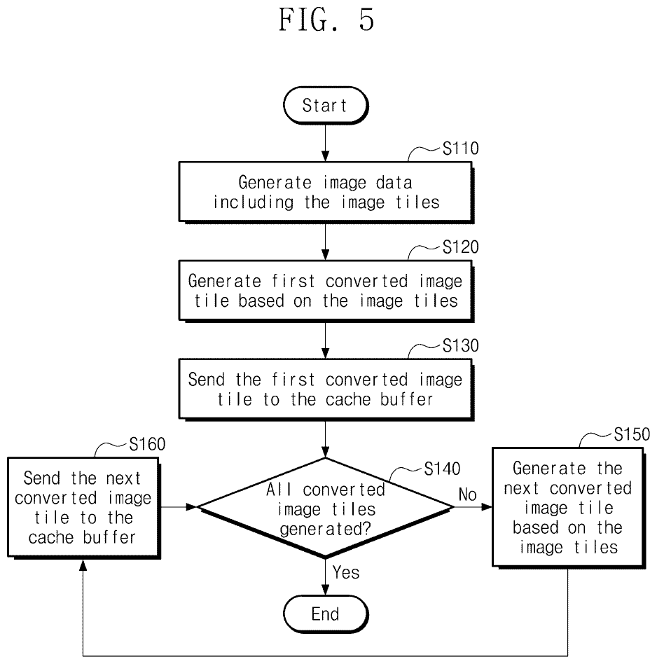

FIG. 5 is a flowchart illustrating an example of an operation method of a second processor of FIG. 1, according to an embodiment of the present disclosure. Through FIGS. 1 to 5, an operation method of the second processor 120, according to an embodiment of the present disclosure is described.

In operation S110, the second processor 120 may generate image data including image tiles. In some embodiments, the second processor 120 may generate the image data and may store the generated the image data in the cache buffer 130 or the host memory 220 of FIG. 2. For example, the second processor 120 may generate image data including a plurality of image tiles and may store the generated image data in the cache buffer 130. Although operation S110 is described based on being performed by the second processor 120, the scope of the present disclosure is not limited thereto, and it should be understood that an embodiment in which the first processor 110 (or the main processor) generates image data including one or more image tiles, or an embodiment in which the second processor 120 loads the generated image from the cache buffer 130 is also within the scope of the present disclosure.

In operation S120, the second processor 120 may generate a first converted image tile based on the image tiles. In some embodiments, the second processor 120 may generate a first converted image tile including one or more pixel data of each of adjacent image tiles used for the kernel processing KP of the first image tile. For example, when the size of the kernel corresponds to the pixel data of the 3×3 array, the second processor 120 may generate a first converted image tile including pixel data of the first image tile and pixel data forming a boundary between the first image tile and the adjacent image tiles.

In operation S130, the second processor 120 may send the first converted image tile to the cache buffer 130. In some embodiments, the second processor 120 may send the first converted image tile to the cache buffer 130 through the bus interface 125. In some embodiments, the second processor 120 may store the first converted image tile in the cache buffer 130 to match the arrangement of the image tiles in the image data.

In operation S140, the second processor 120 may determine the next operation depending on whether all the converted image tiles are generated. When all the converted image tiles for all the image tiles of the image data are not generated, the second processor 120 may proceed to operation S150. When all the converted image tiles for all the image tiles of the image data are generated, the second processor 120 may terminate the operation.

In operation S150, the second processor 120 may generate the next converted image tile. Based on the same or similar operation as operation S120, the second processor 120 may generate the converted image tile with respect to the next image tile. In some embodiments, the second processor 120 may generate the next converted image tile including one or more pixel data of each of the adjacent image tiles used for the kernel processing KP of the next image tile. For example, when the size of the kernel corresponds to the pixel data of the 3×3 array, the second processor 120 may generate a next converted image tile including pixel data of the next image tile and pixel data forming the boundary between the next image tile and the adjacent image tiles of the next image tile.

In operation S160, the second processor 120 may send the next converted image tile to the cache buffer 130. The second processor 120 may send the next converted image tile to the cache buffer 130 based on the same as or similar to operation S130. In some embodiments, the second processor 120 may send the next converted image tile to the cache buffer 130 through the bus interface 125. In some embodiments, the second processor 120 may store the next converted image tile in the cache buffer 130 to match the arrangement of the image data. After operation S160, the second processor 120 may return to operation S140.

In some embodiments, the second processor 120 may store the generated converted image tiles in the cache buffer 130 to match the arrangement of the image tiles in the image data. In FIG. 5, it is described that the second processor 120 stores the converted image tiles in the cache buffer 130, but the scope of the present disclosure is not limited thereto. In some embodiments, the second processor 120 may store all or part of the converted image tiles in the cache buffer 130 or the host memory 220 of FIG. 2. In some embodiments, the second processor 120 may generate information for restoring the arrangement of the image data ID together with the converted image tiles.

In FIG. 5, it is described that the second processor 120 generates the converted image tile(s) by converting the image tile(s), but the scope of the present disclosure is not limited thereto. It should be understood that an embodiment in which the converted image tile(s) are generated based on the same or similar operation as that of FIG. 5 between the host memory 220 and the system-on-chip 100 of FIG. 2 is also within the scope of the present disclosure. For example, the interface circuit between the system-on-chip 100 and the host memory 220 may generate the converted image tile(s) by converting the image tile(s), and may store the generated converted image tile(s) in the system cache 230 of FIG. 2 or the cache buffer 130 of FIG. 1. As in the above description, it should be understood that an embodiment in which the converted image tile(s) are generated between the storage device 210 and the host memory 220 of FIG. 2 based on the same or similar operation as that of FIG. 5 is also within the scope of the present disclosure. For example, the interface circuit (or a memory controller of the host memory 220, etc.) between the storage device 210 and the host memory 220 outside the system-on-chip 100 may convert each of the image tile(s) to generate the converted image data including the converted image tile(s), and may store the generated converted image data in the host memory 220.

The operation method(s) described through FIG. 5 are an example, and the scope of the present disclosure is not limited thereto. At least some of operations of FIG. 5 may be performed simultaneously or in an overlapping manner. It should be understood that an embodiment in which the order of at least some of operations described in FIG. 5 is modified and performed is also within the scope of the present disclosure. The size of the kernel described in FIG. 5 is an example, and the scope of the present disclosure is not limited thereto. When the size of the kernel increases, the number of pixel data of adjacent image tiles included in the converted image tile may increase. Referring to the drawings below, an embodiment in which the second processor 120 generates the converted image tile(s) from image tile(s) described through FIGS. 2 to 5 is described, but this is an example and the scope of the present disclosure is not limited thereto.

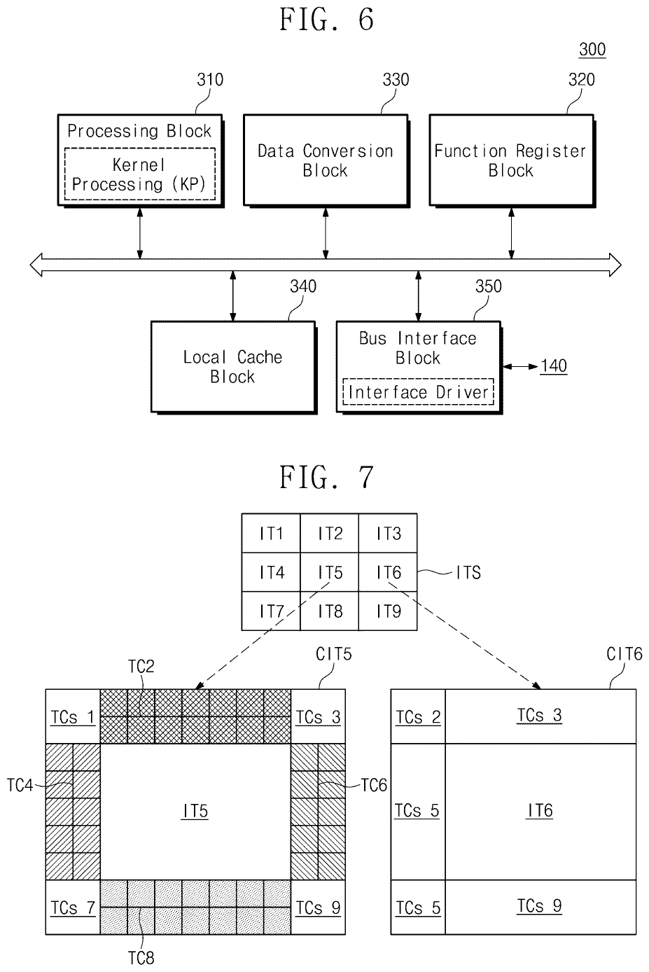

FIG. 6 is a block diagram illustrating in detail an example of a second processor of FIG. 1, according to an embodiment of the present disclosure. Referring to FIG. 6, a second processor 300 may correspond to the second processor 120 of FIG. 1. The second processor 300 may include a processing block 310, a function register block 320, a data conversion block 330, a local cache block 340, and a bus interface block 350.

The processing block 310 may control the overall operation of the second processor 300 or may provide operations required for the operation of the second processor 300. In some embodiments, the processing block 310 may provide one or more of various operations (e.g., specialized operations). For example, the processing block 310 may provide one or more of various operations, such as floating point operations, graphics operations, neural network operations, matrix operations, tensor operations, convolution operations, neuromorphic operations, or combinations thereof. In some embodiments, the processing block 310 may perform one or more of various algorithms and may output results.

The processing block 310 may provide the kernel processing KP. For example, the processing block 310 may perform the kernel processing on the image tiles or the converted image tiles of FIGS. 2 to 4. In some embodiments, the kernel size of the kernel processing KP of the processing block 310 may be determined by software, firmware, or an application programmable interface (API). For example, the processing block 310 may be determined by firmware to provide the kernel processing KP for a kernel corresponding to pixel data of a 3×3 array. In some embodiments, the processing block 310 may further include one or more registers that store data (e.g., filter data, weight data, etc.) used for the operations.

The function register block 320 may store settings necessary for the operation of the second processor 300. In some embodiments, the function register block 320 may store information on the kernel size of the kernel processing KP, or information necessary for the data conversion DC. For example, the function register block 320 may store information necessary for the data conversion DC, such as information about the size of image data, the number of each image tile, or the size of each image tile. In some embodiments, the information stored in the function register block 320 may be generated or set by a driver, firmware, or an API.

The data conversion block 330 may control or manage the data conversion DC. In some embodiments, the data conversion block 330 may control or manage the data conversion DC based on information of the function register block 320. For example, the data conversion block 330 may control or manage the data conversion DC of image tiles, or manage generation of the converted image tiles, based on information such as the size of an image tile or the size of a kernel stored in the function register block 320.

In some embodiments, the data conversion block 330 may perform the data conversion DC of an image tile based on controlling the bus interface block 350. For example, the data conversion block 330 may allow the bus interface block 350 to duplicate pixel data forming the boundary of the image tile to be sent to the cache buffer 130. In some embodiments, the data conversion block 330 may notify the processing block 310 that data duplication for the data conversion DC of the image tile is necessary. For example, the processing block 310 may duplicate pixel data forming the row boundary of the image tiles to be sent to the cache buffer 130 based on the notification of the data conversion block 330.

In some embodiments, the data conversion block 330 may control or manage the data conversion DC from the converted image tile to the image tile. For example, the data conversion block 330 may generate the image tile from the converted image tile or may manage the data conversion DC from the converted image tile to the image tile, based on the data transmission control of the bus interface block 350.

In some embodiments, the data conversion block 330 may perform an operation on the data conversion DC. For example, the data conversion block 330 may read out a plurality of pixel data included in the converted image tile from the cache buffer 130 of FIG. 1 or the system cache 230 of FIG. 2 (or may control the second processor 120 to read out). In this case, the data conversion block 330 may write the plurality of pixel data thus read out into the local cache block 340 to match the arrangement or structure of the converted image tile.

The local cache block 340 may store data necessary for the operation of the second processor 300. The local cache block 340 may correspond to the local cache 240 of FIG. 2 or may be identical to or similar to the local cache 240 of FIG. 2. In some embodiments, the local cache block 340 may store data on which the kernel processing KP is performed. For example, the local cache block 340 may store an image tile on which the kernel processing KP is performed (e.g., one of the image tiles ITS of FIG. 3), or the converted image tile on which the kernel processing KP is performed (e.g., one of the converted image tiles CITS of FIG. 4). In some embodiments, the local cache block 340 may store data required for the kernel processing KP. For example, the local cache block 340 may store operation data used for the kernel processing KP, such as filter data or weight data.

In some embodiments, the local cache block 340 may have the highest level in the memory hierarchy of the second processor 300. In some embodiments, the local cache block 340 may provide at least a portion or all of the data on which the kernel processing KP is performed to the processing block 310. For example, the local cache block 340 may provide one or more pixel data included in a kernel area on which the kernel processing KP is performed to the processing block 310.

In some embodiments, the local cache block 340 may store instructions executed by the processing block 310. In some embodiments, the local cache block 340 may load or store the converted image tile to match the cache alignment. For example, the local cache block 340 may load or store the converted image tile on which the kernel processing operation is performed to match the cache alignment.

The bus interface block 350 may perform communication for the second processor 300. The bus interface block 350 may correspond to the bus interfaces 115 and 125 of FIG. 1. In some embodiments, the bus interface block 350 may perform communication with the bus 140 of FIG. 1. For example, the bus interface block 350 may send data to other components within the system-on-chip 100 of FIG. 1 or may receive data from other components within the system-on-chip 100 of FIG. 1 through the bus 140 of FIG. 1. In some embodiments, the bus interface block 350 may include an interface driver and may define or manage operations (e.g., data transmission and reception) based on the interface driver.

In some embodiments, the bus interface block 350 may capture some or all of the data to be sent. For example, the bus interface block 350 may capture at least some of the pixel data sent by the second processor 300. In some embodiments, the bus interface block 350 may send the captured data back (e.g., to the cache buffer 130 of FIG. 1). In some embodiments, the bus interface block 350 may include one or more registers capable of capturing one or more pixel data.

In some embodiments, the bus interface block 350 may operate in response to the control of the processing block 310 or the data conversion block 330. For example, the bus interface block 350 may send, in response to the control of the processing block 310, the converted image tile, or a result of generating the kernel processing KP (e.g., the image tile including a result generated by the kernel processing KP or the converted image tile) to the cache buffer 130 of FIG. 1. For another example, the bus interface block 350 may perform, in response to the control of the data conversion block 330, capturing one or more pixel data to generate the converted image tile. In this case, the bus interface block 350 may send one or more captured pixel data to the bus 140 in response to the control of the data conversion block 330.

The second processor 300 described through FIG. 6 is an example, and the scope of the present disclosure is not limited thereto. The blocks described through FIG. 6 may be functionally distinct blocks. It should be understood that an embodiment in which one block of FIG. 6 includes another block, or an embodiment in which other blocks perform part or all of the functions of one block, is also within the scope of the present disclosure.

FIG. 7 is a diagram illustrating an example of converted image tiles, according to an embodiment of the present disclosure. Through FIGS. 1 to 7, examples of converted image tiles, according to an embodiment of the present disclosure are described.

In FIG. 7, the second processor 120 of FIG. 1 may perform kernel-based kernel processing KP corresponding to pixel data of a 5×5 array. Referring to FIG. 7, the image tiles ITS may include first to ninth image tiles IT1 to IT9. In some embodiments, the image tiles ITS may be all or part of the image data. In FIG. 7, the converted image tiles of each of the fifth image tile IT5 and the sixth image tile IT6 are illustrated as examples, but it should be understood that the converted image tiles corresponding to other image tiles may also be generated identically or similarly.

A fifth converted image tile CIT5 may include the fifth image tile IT5 in the center. In some embodiments, the fifth converted image tile CIT5 may include pixel data of adjacent image tiles necessary for kernel processing of the pixel data of the fifth image tile IT5. For example, the fifth converted image tile CIT5 may include pixel data at a distance of two pixel data from the boundary of the fifth image tile IT5. For a more detailed example, the fifth converted image tile CIT5 may include pixel data forming the right column boundary of the fourth image tile IT4 and pixel data on the immediate left, and may include pixel data of the two rows and two columns from the rightmost bottom of the first image tile IT1. Since the fifth image tile IT5 includes pixel data in a 5×7 array, the fifth converted image tile may include pixel data in a 9×11 array.

The sixth converted image tile CIT6 may include the sixth image tile IT6 and some of the pixel data of image tiles adjacent to the sixth image tile IT6. In some embodiments, the sixth converted image tile CIT6 may include pixel data of adjacent image tiles necessary for the kernel processing KP of the sixth image tile IT6. As the sixth image tile IT6 includes pixel data in a 5×7 array and forms the right boundary of the image tiles ITS, the sixth converted image tile CIT6 may include pixel data in a 9×9 array.

The converted image tiles illustrated in FIG. 7 are an example and the scope of the present disclosure is not limited thereto. It should be understood that embodiments in which the image tiles have arbitrary sizes or the kernels have arbitrary sizes are also within the scope of the present disclosure. In some embodiments, the converted image tile may include data required for performing the kernel processing KP on all pixel data of the target image tile. Although FIG. 7 is described based on the image tiles ITS being the same as the image data, the present disclosure is not limited thereto. It should be understood that embodiments in which the image tiles ITS are arranged in a different form or embodiments in which the image tiles ITS are part of the image data are also within the scope of the present disclosure. In some embodiments, the converted image tiles of FIG. 7 may be stored in the system cache 230 of FIG. 2 or the host memory 220 of FIG. 2.

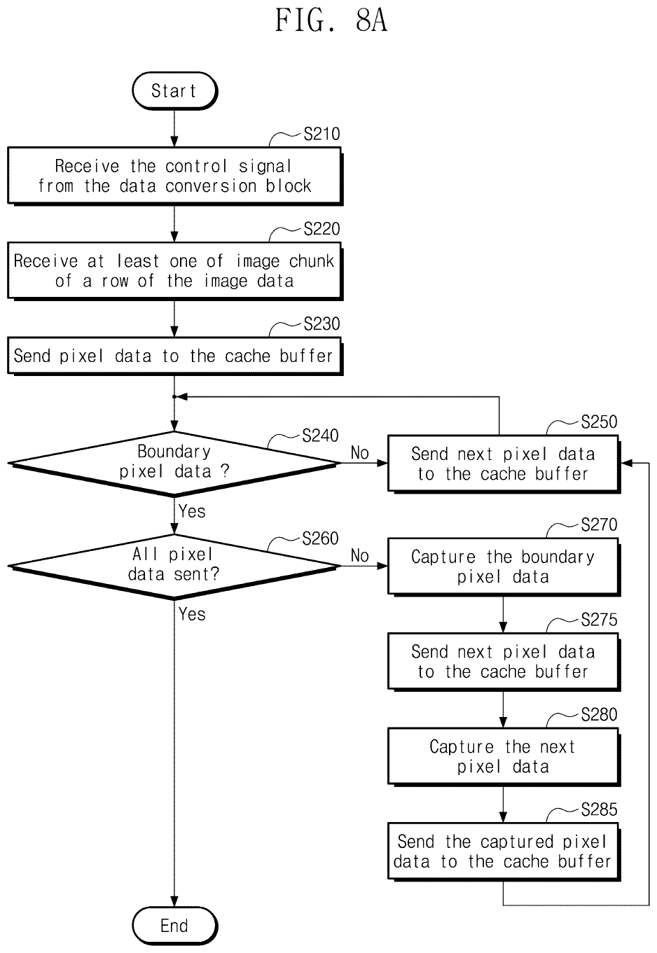

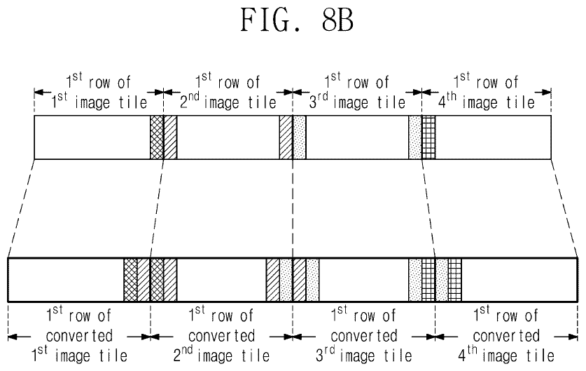

FIG. 8A is a flowchart illustrating how a bus interface block of FIG. 6 generates a row of converted image tiles from a row of image data, according to an embodiment of the present disclosure. Through FIGS. 1 to 6 and FIG. 8A, an example of an operation method of the bus interface block 350 according to an embodiment of the present disclosure is described. FIG. 8A describes that the second processor 300 performs the kernel processing KP based on a kernel corresponding to pixel data of a 3×3 array, but this is an example and the scope of the present disclosure is not limited thereto.

In operation S210, the bus interface block 350 may receive a control signal from the data conversion block 330. In some embodiments, the bus interface block 350 may receive a control signal including information about the size of an image tile or the size of a kernel of kernel processing from the data conversion block 330. In operation S220, the bus interface block 350 may receive data to be sent. In some embodiments, the bus interface block 350 may receive one or more of the pixel data forming the first row of image data to be converted. For example, the bus interface block 350 may receive one of the pixel data forming the first row of the image data.

The second processor 120 may load one row of the image data into the second processor 120 before operation S220. In some embodiments, the second processor 120 may load or store one row of the image data to be converted from the cache buffer 130 or the host memory 220 into the local cache block 340 before operation S210 or operation S220. For example, the second processor 120 may load one row of the image data to be converted from the cache buffer 130 to the local cache 240 simultaneously with operation S210.

In operation S230, the bus interface block 350 may send the pixel data to the cache buffer 130. For example, the bus interface block 350 may send pixel data to the cache buffer 130 through the bus 140.

In operation S240, the bus interface block 350 may determine the next operation based on whether the pixel data (in operation S230 or operation S250 described below) thus sent is boundary pixel data. The boundary pixel data may be pixel data forming or configuring a boundary between image tiles. In some embodiments, the bus interface block 350 may determine the next operation based on whether the pixel data thus sent is a tile forming a column boundary of an image tile. When the pixel data thus sent is not boundary pixel data, the bus interface block 350 may proceed to operation S250. When the pixel data thus sent is boundary pixel data, the bus interface block 350 may proceed to operation S260.

In operation S250, the bus interface block 350 may send next pixel data to the cache buffer 130. The bus interface block 350 may perform operation S250 in the same or similar manner as operation S230. After operation S250, the bus interface block 350 may return to operation S240.

In operation S260, the bus interface block 350 may determine the next operation based on whether all pixel data are sent. When all pixel data are sent, the bus interface block 350 may end the operation. When all pixel data are not sent, the bus interface block 350 may proceed to operation S270.

In operation S270, the bus interface block 350 may capture the sent pixel data. In some embodiments, the bus interface block 350 may capture the sent pixel data in a register within the bus interface block 350. In operation S275, the bus interface block 350 may send next pixel data to the cache buffer 130. The bus interface block 350 may perform operation S275 in the same or similar manner as operation S230 or operation S250.

In operation S280, the bus interface block 350 may capture the pixel data sent in operation S275. The bus interface block 350 may perform operation S280 based on the same or similar operation as operation S270. In operation S285, the bus interface block 350 may send the captured pixel data to the cache buffer 130. In some embodiments, the bus interface block 350 may send the pixel data to the cache buffer 130 in the captured order. For example, the bus interface block 350 may sequentially send the pixel data captured in operation S270 and the pixel data captured in operation S280 to the cache buffer 130. After operation S285 ends, the bus interface block 350 may return to operation S250 and may perform the next operation.

In FIG. 8A, the bus interface block 350 is described as generating one row of the converted image tiles and terminating the operation, but the present disclosure is not limited thereto. It should also be understood that the embodiment in which the bus interface block 350 returns to operation S210 to generate the next row is also within the scope of the present disclosure.

In some embodiments, the bus interface block 350 may receive pixel data to be sent to the cache buffer 130 at each operation or two or more pixel data including pixel data to be sent to the cache buffer 130 at each operation, in operation S250 or before (or immediately before) operation S275. In some embodiments, the bus interface block 350 may send any pixel data before or after sending pixel data forming a boundary (column boundary) of the image data such that the sizes of the converted image tiles are the same. For example, the bus interface block 350 may send pixel data whose values are formed as “0” before sending the first pixel data of one row of the image data or after sending the last pixel data.

It should be understood that embodiments in which at least some of the operations of FIG. 8A are overlapped or performed simultaneously, or embodiments in which at least some of the operations of FIG. 8A are performed in a reversed order, are also within the scope of the present disclosure. In some embodiments, the bus interface block 350 may perform the above-described operations based on the control of the data conversion block 330. For example, the data conversion block 330 may perform the determination of operation S240 or operation S260, and may control the bus interface block 350 by selecting the next operation to be performed by the bus interface block 350 based on the determination result. In some embodiments, the data conversion block 330 may control the bus interface block 350 based on information such as the size (or the number of pixel data in the row direction) of the image tiles included in the function register block 320, or the size of the kernel. FIG. 8A is described based on an example of generating one row of the converted image tiles with respect to one row of image data, but the scope of the present disclosure is not limited thereto. It should be understood that an embodiment of generating one row of the converted image tiles with respect to one row of a first part of image data based on the same or similar operation(s) as the operation(s) described through FIG. 8A is also within the scope of the present disclosure. Although the embodiment of sending data to the cache buffer 130 by the bus interface block 350 in FIG. 8A is described, it should be understood that an embodiment of sending the sent data to the host memory 220 of FIG. 2 by the second processor 300 is also within the scope of the present disclosure.

FIG. 8B is a diagram illustrating one row of converted image tiles generated by a method of FIG. 8A, according to an embodiment of the present disclosure. Through FIGS. 8A and 8B, an example of one row of the converted image tiles generated based on the data conversion DC operation of the present disclosure is described.

Referring to FIG. 8B, a first row of each of the first to fourth image tiles is illustrated. Pixel data adjacent to neighboring image tiles and forming a boundary of the image tiles is illustrated with different cross-hatching. The image tile forming the boundary of a first image tile is illustrated in a check pattern, the image tile forming the boundary of a second image tile is illustrated in a diagonal pattern, the image tile forming the boundary of a third image tile is illustrated in a dotted pattern, and the image tile forming the boundary of a fourth image tile is illustrated in a grid pattern.

In FIG. 8B, a first row of the converted image tiles is illustrated. In FIG. 8B, the converted image tiles are illustrated in a form in which they are attached to each other, but this is an example and the scope of the present disclosure is not limited thereto.

The right boundary of the first row of a first converted image tile may include the rightmost pixel data of the first row of the first image tile and the leftmost pixel data of the first row of the second image tile. The left boundary of the first row of a second converted image tile may include the rightmost pixel data of the first row of the first image tile and the leftmost pixel data of the first row of the second image tile. The right boundary of the first row of a third converted image tile may include the rightmost pixel data of the first row of the third image tile and the leftmost pixel data of the first row of the fourth image tile. The left boundary of the first row of a fourth converted image tile may include the rightmost pixel data of the first row of the third image tile and the leftmost pixel data of the first row of the fourth image tile. Based on the operation of FIG. 8A, pixel data corresponding to the boundary of the image tiles may be duplicated and included in each of the converted image tiles. Based on the operation of FIG. 8A, since the generated converted image tiles include all data required for the kernel processing KP of the corresponding image tile, cache misses that may occur during the kernel processing KP process of the image tiles may be eliminated or may be reduced.

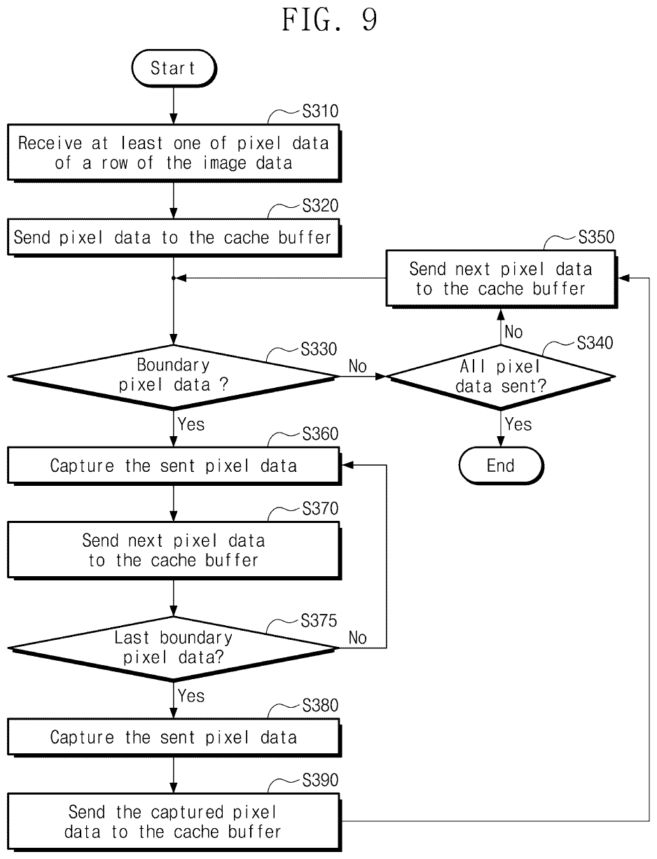

FIG. 9 is a flowchart illustrating how a bus interface block of FIG. 6 generates a row of converted image tiles from a row of image data, according to an embodiment of the present disclosure. FIG. 9 may be an operation of the bus interface block 350 when, unlike FIG. 8A, the kernel of the second processor 300 performs kernel-based kernel processing corresponding to pixel data of an array of 5×5 or more. Through FIGS. 1 to 7 and FIG. 9, an example of an operation method of the bus interface block 350 according to an embodiment of the present disclosure is described.

In operation S310, the bus interface block 350 may receive data thus sent. In some embodiments, the bus interface block 350 may receive one or more of the pixel data forming the first row of image data to be converted. For example, the bus interface block 350 may receive one of the pixel data forming the first row of the image data. The bus interface block 350 may perform operation S310 identically or similarly to operation S220 of FIG. 8A.

The second processor 120 may load one row of the image data into the second processor 120 before operation S310. In some embodiments, the second processor 120 may load or store one row of image data to be converted from the cache buffer 130 or the host memory 220 into the local cache block 340 before operation S310. For example, the second processor 120 may load one row of the image data to be converted from the cache buffer 130 into the local cache 240 simultaneously with the operation S310. In some embodiments, the bus interface block 350 may receive a control signal related to data conversion from the data conversion block 330 before operation S310 (e.g., identical to or similar to operation S210 of FIG. 8).

In operation S320, the bus interface block 350 may send the pixel data to the cache buffer 130. For example, the bus interface block 350 may send pixel data to the cache buffer 130 through the bus 140. The bus interface block 350 may perform operation S320 identically to or similarly to operation S230 of FIG. 8.

In operation S330, the bus interface block 350 may determine the next operation based on whether the sent pixel data (in operation S320 or operation S350) is included in the boundary pixel data. The boundary pixel data may be pixel data belonging to the boundary range between image tiles or may include pixel data used for kernel processing of adjacent image tiles. In some embodiments, the range of the boundary pixel data may be determined based on the size of the kernel of the kernel processing KP. For example, when the kernel corresponds to pixel data of a 5×5 array, the two pixel data closest to the boundary between the image tiles may be the boundary pixel data.

The bus interface block 350 may proceed to operation S340 when the sent pixel data do not belong to the boundary pixel data. The bus interface block 350 may proceed to operation S360 when the sent pixel data belong to the boundary pixel data.

In operation S340, the bus interface block 350 may determine the next operation based on whether all pixel data are sent. When all pixel data are sent, the bus interface block 350 may end the operation. When all pixel data are not sent, the bus interface block 350 may proceed to operation S350.

In operation S350, the bus interface block 350 may send next pixel data to the cache buffer 130. The bus interface block 350 may perform operation S350 in the same or similar manner as operation S230, operation S250, operation S275, or operation S285 of FIG. 8A, or operation S320. After operation S350, the bus interface block 350 may return to operation S330.

In operation S360, the bus interface block 350 may capture the sent pixel data (in operation S320, operation S350, or operation S370). In some embodiments, the bus interface block 350 may capture the sent pixel data in a register within the bus interface block 350. The bus interface block 350 may perform operation S360 in the same or similar manner as operation S270 or operation S280 of FIG. 8A.

In operation S370, the bus interface block 350 may send next pixel data to the cache buffer 130. The bus interface block 350 may perform the operation S370 in the same or similar manner as operation S230, operation S250, operation S275, or operation S285 of FIG. 8A, or operation S320 or operation S350.

In operation S375, the bus interface block 350 may determine next operation based on whether the sent pixel data (in operation S370) are the last pixel data among the boundary pixel data. The bus interface block 350 may perform operation S375 in the same or similar manner as operation S240 of FIG. 8A or operation S330. When the sent pixel data are not the last pixel data among the boundary pixel data, the bus interface block 350 may return to operation S360. When the sent pixel data are the last pixel data among the boundary pixel data, the bus interface block 350 may proceed to operation S380.

In operation S380, the bus interface block 350 may capture the sent pixel data (in previous operation S370). In some embodiments, the bus interface block 350 may capture the sent pixel data in a register within the bus interface block 350. The bus interface block 350 may perform operation S380 in the same or similar manner as operation S270 or operation S280 of FIG. 8A, or operation S360.

In operation S390, the bus interface block 350 may send the captured pixel data to the cache buffer 130. The bus interface block 350 may perform operation S390 in the same or similar manner as operation S285 of FIG. 8A. In some embodiments, the bus interface block 350 may sequentially send the captured pixel data to the cache buffer 130. After operation S390 ends, the bus interface block 350 may return to operation S350 and may perform the next operation.

In FIG. 9, the bus interface block 350 is described as generating one row of the converted image tiles and terminating the operation, but the present disclosure is not limited thereto. It should also be understood that the embodiment in which the bus interface block 350 returns to operation S310 to generate the next row is also within the scope of the present disclosure.

In some embodiments, the bus interface block 350 may receive two or more pixel data, including pixel data to be sent to the cache buffer 130 at each operation or pixel data to be sent to the cache buffer 130 at each operation, in operation S350 or before (or immediately before) operation S370. In some embodiments, the bus interface block 350 may send any pixel data before or after sending pixel data forming a boundary (column boundary) of the image data such that the sizes of the converted image tiles are the same. For example, the bus interface block 350 may send pixel data whose values are formed as “0” in advance before sending the first pixel data of one row of image data or after sending the last pixel data.

It should be understood that embodiments in which at least some of the operations of FIG. 9 are overlapped or performed simultaneously, or embodiments in which at least some of the operations of FIG. 9 are performed in a reversed order, are also within the scope of the present disclosure. In some embodiments, the bus interface block 350 may perform the above-described operations based on the control of the data conversion block 330. For example, the data conversion block 330 may perform the determination of operation S330, operation S340, or operation S375, and may control the bus interface block 350 by selecting the next operation to be performed by the bus interface block 350 based on the determination result. In some embodiments, the data conversion block 330 may control the bus interface block 350 based on information such as the size (or the number of pixel data in the row direction) of the image tiles included in the function register block 320, or the size of the kernel. FIG. 9 is described based on an example of generating one row of the converted image tiles with respect to one row of image data, but the scope of the present disclosure is not limited thereto. It should be understood that an embodiment of generating one row of the converted image tiles with respect to one row of a first part of image data based on the same or similar operation(s) as the operation(s) described through FIG. 9 is also within the scope of the present disclosure. Although the embodiment of sending data to the cache buffer 130 by the bus interface block 350 in FIG. 9 is described, it should be understood that an embodiment of sending the sent data to the host memory 220 of FIG. 2 (by the second processor 300) is also within the scope of the present disclosure.

In FIG. 8A and FIG. 9, an embodiment in which the bus interface block 350 of the second processor 300 generates one row of the converted image tiles based on the operation of sending and receiving pixel data is described, but the scope of the present disclosure is not limited thereto. Referring to FIG. 2 together, it should be understood that an embodiment in which the interface circuit between the host memory 220 and the system cache 230 generates one row of the converted image tiles based on the operation(s) identical to or similar to the operation(s) of FIG. 8A or FIG. 9 is also within the scope of the present disclosure. As in the above description, it should be understood that an embodiment in which the interface circuit between the storage device 210 and the host memory 220 generates one row of the converted image tiles based on the operation(s) identical to or similar to the operation(s) of FIG. 8A or FIG. 9 is also within the scope of the present disclosure.

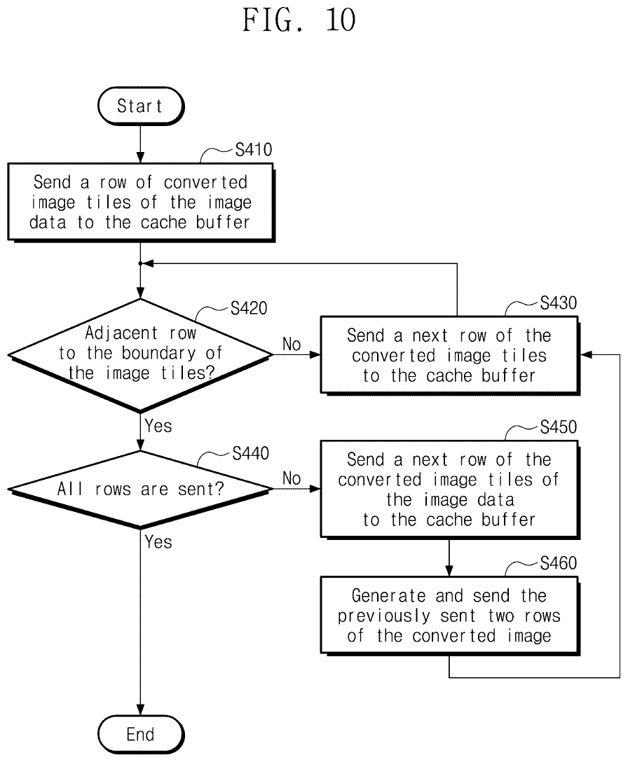

FIG. 10 is a flowchart illustrating an example of how a second processor of FIG. 6 generates converted image tiles of image data, according to an embodiment of the present disclosure. A method of generating the converted image tiles of image data through FIGS. 1 to 10 is described. FIG. 10, similar to FIG. 8, describes that the second processor 300 performs the kernel processing KP based on a kernel corresponding to pixel data of a 3×3 array, but this is an example and the scope of the present disclosure is not limited thereto.

In operation S410, the second processor 300 may send one row of the converted image tiles of the image data to the cache buffer 130. In some embodiments, the second processor 300 may generate one row of the converted image tiles or may send one row of the converted image tiles to the cache buffer 130 based on the operations described through FIGS. 8A and 8B. In the following operations (e.g., operations S430, S450, or S460), the row(s) of the converted image tiles sent from the second processor 300 to the cache buffer 130 may be generated or sent to the cache buffer 130 based on the same or similar operation as operation S410.

In operation S420, the second processor 300 may determine the next operation based on whether one row of the sent converted image tiles (in operation S410 or operation S430 described below) forms a boundary between image tiles. In some embodiments, the second processor 300 may determine the next operation based on whether one row of the sent converted image tiles forms a boundary in the row direction between image tiles. When one row of the sent converted image tiles does not form a boundary between image tiles, the second processor 300 may proceed to operation S430. The second processor 300 may proceed to operation S440 when one row of the sent converted image tiles forms a boundary of the image tiles.

In operation S430, the second processor 300 may send the next row of the converted image tiles to the cache buffer 130. In some embodiments, the second processor 300 may perform operation S430 based on the operations described through FIGS. 8A and 8B or the operations identical to or similar to operation S410. After operation S430 is terminated, the second processor 300 may return to operation S420.

In operation S440, the second processor 300 may determine the next operation depending on whether all rows of the converted image tiles are sent. When all rows of the converted image tiles are sent to the cache buffer 130, the second processor 300 may terminate the operation. In contrast, when all the rows of the converted image tiles are not sent to the cache buffer 130, the second processor 300 may proceed to operation S450.

In operation S450, the second processor 300 may send the next row of the converted image tiles of the image data to the cache buffer. The second processor 300 may perform operation S450 based on an operation identical to or similar to operation S410. In some embodiments, the row of the sent converted image tiles in operation S450 and the row of the sent converted image tiles immediately before may include pixel data forming the row boundary of the image tiles.

In operation S460, the second processor 300 may send the rows of two previously sent converted image tiles back to the cache buffer 130. In some embodiments, the second processor 300 may sequentially send the row sent before operation S450 and the row sent in operation S450 to the cache buffer 130. In some embodiments, the second processor 300 may load all or part of the two rows sent immediately before into the local cache block 340, and then may perform operation S460. After operation S460, the second processor 300 may return to operation S430.

Based on operations S450 and S460, the second processor 300 may generate the converted image tiles including pixel data forming the row boundary of image tiles adjacent to the row boundary of each of the image tiles (aligned in the row direction). Based on the operations of FIGS. 8 and 10, the second processor 300 may generate the converted image tiles including data for kernel processing of each of one or more image tiles of the image data.

Based on the operation(s) of FIG. 10, the second processor 300 may generate the converted image tiles corresponding to the image tiles of the image data. In some embodiments, the second processor 300 may manage boundary information of each of the converted image tiles. For example, the second processor 300 may manage the boundary information of the converted image tiles based on information of pixel data including vertices of each of the converted image tiles or information about the position where they are stored. For another example, the second processor 300 may manage the boundary information of the converted image tiles by generating metadata of the converted image tiles. In some embodiments, the second processor 300 may write the converted image tiles into the cache buffer 130 based on an arbitrary data structure, and may load one converted image tile for the kernel processing KP into the local cache 240 by referring to the boundary information. In some embodiments, the second processor 300 may manage the boundary of the converted image tiles by (logically or physically) dividing the space in which each of the converted image tiles is written into the cache buffer 130. For example, referring to FIG. 8A together, the second processor 300 may write data corresponding to the next converted image tiles (e.g., in operation S285 or operation S460) into an area (logically or physically) separated from an area where previous converted image tiles are stored in the cache buffer 130 such that the converted image tiles are logically or physically separated from each other. That is, the second processor 300 may store each of the converted image tiles in a (logically or physically) separated space. The second processor 300 may load one converted image tile to be the target of the kernel processing KP into the local cache block 340 based on the boundary information of each of the converted image tiles.

It should be understood that embodiments in which at least some of the operations of FIG. 10 are overlapped or performed simultaneously, or embodiments in which at least some of the operations of FIG. 10 are performed in a reversed order, are also within the scope of the present disclosure. In some embodiments, the second processor 300 may manage or control the operations of FIG. 10 through the data conversion block 330. For example, the second processor 300 may perform the determination of operation S420 or operation S440 through the data conversion block 330. In some embodiments, the data conversion block 330 may perform the determination of operation S420 or operation S440 based on the information of the image tiles included in the function register block 320, the information of the kernels, and the data transmission aspect of the bus interface block 350. In some embodiments, the second processor 300 may make the sizes of the individual converted image tiles all the same. For example, the second processor 300 may send pixel data corresponding to the row length of the converted image tiles and including a value of “0” to the cache buffer 130 before and after the operation of FIG. 10. In this case, each of the image tiles may include pixel data in an “m”×“n” array, and each of the converted image tiles may include pixel data in an (m+2)×(n+2) array.

Although FIG. 10 is described based on that the second processor 300 generates all of the converted image tiles for the entire image data, this is an example and the present disclosure is not limited thereto. It should be understood that an embodiment in which the second processor 300 generates the converted image tiles for a first part of the image data based on an operation identical to or similar to the operation of FIG. 10 is also within the scope of the present disclosure. Although FIG. 10 is described based on that the second processor 300 stores all of the generated converted image tiles in the cache buffer 130, the scope of the present disclosure is not limited thereto. It should be understood that an embodiment in which the second processor 300 stores some or all of the generated converted image tiles in the host memory 220 is also within the scope of the present disclosure.

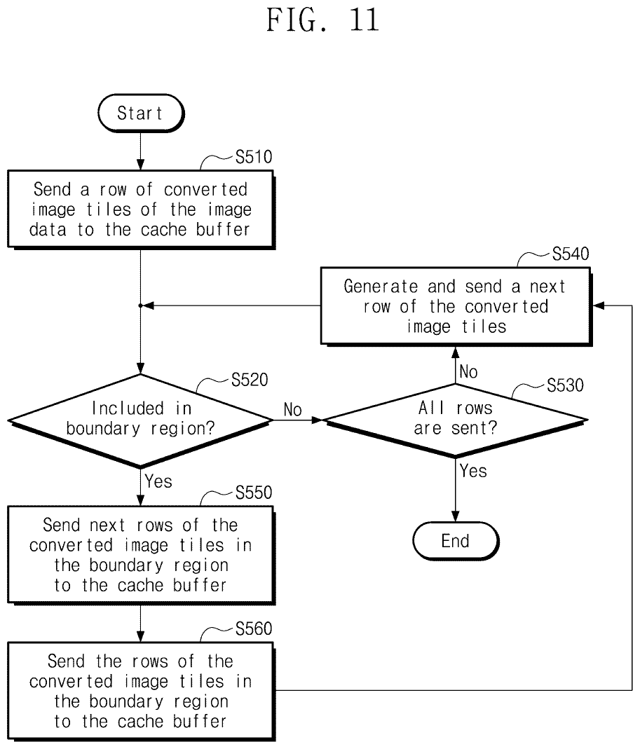

FIG. 11 is a flowchart illustrating an example of how a second processor of FIG. 6 generates converted image tiles of image data, according to an embodiment of the present disclosure. FIG. 11 may illustrate an operation of the bus interface block 350 in a case where, unlike FIG. 10, the kernel of the second processor 300 performs kernel-based kernel processing corresponding to pixel data of an array of 5×5 or more. Through FIGS. 1 to 7, FIG. 9, and FIG. 11, an operation method for generating all converted image tiles of image data according to an embodiment of the present disclosure is described.

In operation S510, the second processor 300 may send one row of the converted image tiles of the image data to the cache buffer 130. In some embodiments, the second processor 300 may generate one row of the converted image tiles or may send one row of the converted image tiles to the cache buffer 130, based on the operation(s) described through FIG. 9. In the following operations (e.g., operations S540, S550, or S560), the row(s) of the converted image tiles sent from the second processor 300 to the cache buffer 130 may be generated or sent to the cache buffer 130 based on the same or similar operation as operation S510.

In operation S520, the second processor 300 may determine the next operation based on whether one row of the converted image tiles sent (in operation S510 or operation S540) is included in the boundary area. The boundary area may include row(s) included in pixel data used for kernel processing of adjacent image tiles. For example, when the size of the kernel corresponds to pixel data of a 5×5 array, the row included in the boundary area may include four rows, including two rows forming the boundary and two rows immediately above and below the two rows. The second processor 300 may proceed to operation S530 when the sent row is not included in the boundary area. The second processor 300 may proceed to operation S550 when the sent row is included in the boundary area.

In operation S530, the second processor 300 may determine the next operation based on whether all rows are sent. In case all rows are sent, the second processor 300 may end the operation. In contrast, in case all rows are not sent, the second processor 300 may proceed to operation S540.

In operation S540, the second processor 300 may send the next row of the converted image tiles to the cache buffer 130. In some embodiments, the second processor 300 may perform operation S540 based on the operations described through FIG. 9 or operations identical to or similar to those of operation S510. After operation S540 is terminated, the second processor 300 may return to operation S520.

In operation S550, the second processor 300 may send the next rows of the converted image tiles within the boundary area to the cache buffer 130. In some embodiments, the second processor 300 may sequentially send the next rows within the boundary area to the cache buffer. For example, when the size of the kernel corresponds to the pixel data of a 5×5 array, the row forming the boundary of the current converted image tiles, the row forming the boundary of the next converted image tiles, and the next row of the row forming the boundary of the next converted image tiles may be (sequentially) sent to the cache buffer 130.

In operation S560, the second processor 300 may send the rows included in the boundary area to the cache buffer 130. In some embodiments, the second processor 300 may send rows sent in operation S550 and immediately before operation S550 to the cache buffer 130. In some embodiments, the second processor 300 may send rows of the converted image tiles within the boundary area to the cache buffer 130 in the same order as the order sent in the previous operations. In some embodiments, the second processor 300 may load all or part of the rows sent immediately before into the local cache block 340, and then may perform operation S560. After operation S560, the second processor 300 may return to operation S540.

Based on operations S550 and S560, the second processor 300 may generate the converted image tiles including pixel data within the boundary area of image tiles adjacent to image tiles. The second processor 300 may generate the converted image tiles including (for example, all) data for kernel processing of each of one or more image tiles of the image data based on the operations of FIGS. 9 and 11.

Based on the operation(s) of FIG. 11, the second processor 300 may generate the converted image tiles corresponding to the image tiles of the image data. In some embodiments, the second processor 300 may manage boundary information of each of the converted image tiles. For example, the second processor 300 may manage the boundary information of the converted image tiles based on information of pixel data including vertices of each of the converted image tiles or information about the position where they are stored. For another example, the second processor 300 may manage the boundary information of the converted image tiles by generating metadata of the converted image tiles. In some embodiments, the second processor 300 may write the converted image tiles into the cache buffer 130 based on an arbitrary data structure, and may load one converted image tile for the kernel processing KP into the local cache 240 by referring to the boundary information. In some embodiments, the second processor 300 may manage the boundary of the converted image tiles by (logically or physically) dividing the space in which each of the converted image tiles is written into the cache buffer 130. For example, referring to FIG. 9 together, the second processor 300 may write data corresponding to the next converted image tiles (e.g., in operation S390 or operation S560) into an area (logically or physically) separated from an area where previous converted image tiles are stored in the cache buffer 130 such that the converted image tiles are logically or physically separated. That is, the second processor 300 may store each of the converted image tiles in a (logically or physically) separated space. The second processor 300 may load one converted image tile to be the target of the kernel processing KP into the local cache block 340 based on the boundary information of each of the converted image tiles.

It should be understood that embodiments in which at least some of the operations of FIG. 11 are overlapped or performed simultaneously, or embodiments in which at least some of the operations of FIG. 11 are performed in a reversed order, are also within the scope of the present disclosure. In some embodiments, the second processor 300 may manage or control the operations of FIG. 11 through the data conversion block 330. For example, the second processor 300 may perform the determination of operation S520 or operation S530 through the data conversion block 330. In some embodiments, the data conversion block 330 may perform the determination of operation S520 or operation S530 based on the information of the image tiles included in the function register block 320, the information of the kernels, and the data transmission aspect of the bus interface block 350. In some embodiments, the second processor 300 may make the sizes of the individual converted image tiles all the same. For example, the second processor 300 may send pixel data corresponding to the row length of the converted image tiles and including a value of “0” to the cache buffer 130 before and after the operation of FIG. 10. In this case, each of the image tiles may include pixel data of an “m”×“n” array, and when the kernel size corresponds to pixel data of a 5×5 array, each of the converted image tiles may include pixel data of an (m+4)×(n+4) array.

Although FIG. 11 is described based on that the second processor 300 generates all of the converted image tiles for the entire image data, this is an example and the present disclosure is not limited thereto. It should be understood that an embodiment in which the second processor 300 generates the converted image tiles for a first part of the image data based on an operation identical to or similar to the operation of FIG. 11 is also within the scope of the present disclosure. Although FIG. 11 is described based on that the second processor 300 stores all of the generated converted image tiles in the cache buffer 130, the scope of the present disclosure is not limited thereto. It should be understood that an embodiment in which the second processor 300 stores some or all of the generated converted image tiles in the host memory 220 is also within the scope of the present disclosure.

Although the operations of FIG. 10 and FIG. 11 are performed by the second processor 300, the scope of the present disclosure is not limited thereto. Referring to FIG. 2 together, it should be understood that an embodiment in which the host memory 220 (e.g., a memory controller of the host memory 220) generates the converted image tiles based on the same or similar operation(s) as the operation(s) of FIG. 10 or FIG. 11 between the host memory 220 and the system cache 230 is also within the scope of the present disclosure. As in the above description, it should be understood that an embodiment in which the storage device 210 (e.g., a storage controller of the storage device 210) or the host memory 220 (e.g., a memory controller of the host memory 220) generates the converted image tiles or the converted image data including converted image tiles based on the same or similar operation(s) as the operation(s) of FIG. 10 or FIG. 11 between the storage device 210 and the host memory 220 is also within the scope of the present disclosure.

The operations in which the converted image tiles of the image data described through FIGS. 8A to 11 are generated or the converted image tiles are stored in the cache buffer 130 or the host memory 220 are an example and the scope of the present disclosure is not limited thereto. It should be understood that an embodiment in which the converted image tiles are generated based on repeating the operation of generating one row of the converted image tiles and sending them to the cache buffer 130, etc., is also within the scope of the present disclosure. The kernel sizes described through FIGS. 8A to 11 are an example, and it should be understood that an embodiment in which the converted image tiles corresponding to other kernel sizes are generated, is also within the scope of the present disclosure. In FIGS. 8A to 11, the data conversion DC is described based on that a shape of the kernel of kernel processing KP is square, but the scope of the present disclosure is not limited thereto. It should be understood that an embodiment in which the converted image tiles from the image tiles are generated by combining FIGS. 8A or 9 and 10 or 11, depending on the shape of the kernel is also within the scope of the present disclosure.

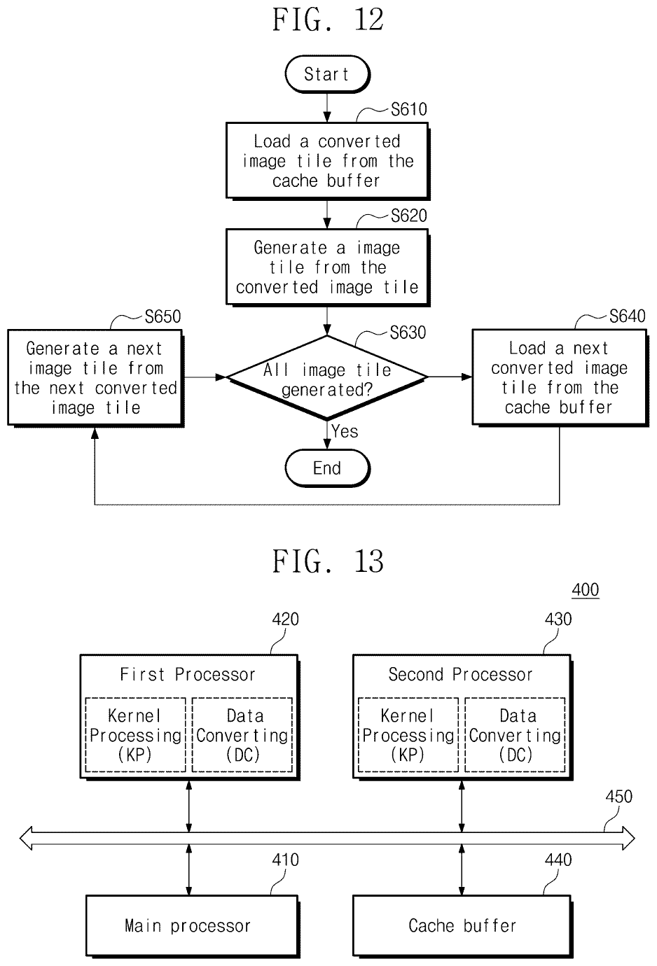

FIG. 12 is a flowchart illustrating an example of a method of converting converted image tiles into image tiles, according to an embodiment of the present disclosure. With reference to FIGS. 1 to 7 and FIG. 12, an example of generating each image tile from the converted image tiles by the second processor 300, according to an embodiment of the present disclosure is described.

In operation S610, the second processor 300 may load the converted image tile from the cache buffer 130 into the second processor 300. In some embodiments, the second processor 300 may load the converted image tile from the cache buffer 130 into the local cache block 340. For example, the second processor 300 may load one converted image tile among all converted image tiles into the local cache block 340.

In operation S620, the second processor 300 may convert the loaded converted image tile into an image tile. In some embodiments, the second processor 300 may generate an image tile from the converted image tile by removing pixel data of adjacent image tiles from the converted image tile. For example, when the size of the kernel corresponds to pixel data of a 3×3 array, and each of the converted image tiles includes pixel data of an (m+2)×(n+2) array, the second processor 300 may generate the image tile by removing pixel data forming the boundary of the converted image tiles. However, this is an example, and the size of the kernel or the size of the converted image tile is not limited thereto.

In some embodiments, the second processor 300 may send the image tile to the cache buffer 130. In some embodiments, the second processor 300 may perform at least a part of the conversion from the converted image tile to the image tile and the transmission of the image tile to the cache buffer 130 simultaneously. For example, the second processor 300 may send only the pixel data of the image tile among the pixel data of the converted image tile to the cache buffer 130, thereby performing at least a part of the conversion operation and the transmission operation simultaneously.

In operation S630, the second processor 300 may determine the next operation based on whether all image tiles of the image data are generated. When all image tiles of the image data are generated, the second processor 300 may end the operation. In contrast, when all image tiles of the image data are not generated, the second processor 300 may proceed to operation S640.

In operation S640, the second processor 300 may load the next converted image tile from the cache buffer 130 into the second processor 300. In some embodiments, the second processor 300 may load the next converted image tile from the cache buffer 130 into the local cache block 340. The second processor 300 may perform operation S640 in the same or similar manner as operation S610.

In operation S650, the second processor 300 may convert the loaded next converted image tile into the next image tile. In some embodiments, the second processor 300 may generate an image tile from the converted image tile by removing pixel data of adjacent image tiles from the converted image tile. In some embodiments, the second processor 300 may send the generated next image tile to the cache buffer 130. In some embodiments, the second processor 300 may perform at least a part of the operation of generating the next image tile and the operation of sending the next image tile to the cache buffer 130 in an overlapping manner. The second processor 300 may perform operation S650 in the same or similar manner as operation S620. The second processor 300 may terminate operation S650 and then may return to operation S630.

The second processor 300 may generate or restore image tiles of image data from the converted image tiles based on the operation of FIG. 12. In some embodiments, the second processor 300 may perform some or all of the operations of FIG. 12 through the data conversion block 330. For example, the data conversion block 330 may control the bus interface block 350 such that the bus interface block 350 sends only the pixel data of the corresponding image tile among the pixel data of the converted image tile to the cache buffer 130. In this case, the data conversion block 330 may control the bus interface block 350 based on information such as the size of the kernel in the function register block 320 or the size of the image tile. For a more detailed example, the data conversion block 330 may control the bus interface block 350 such that the pixel data of each of the adjacent image tiles in the converted image tile is not sent to the cache buffer 130.

In some embodiments, the second processor 300 may manage boundary information of each of the image tiles. For example, the second processor 300 may manage the boundary information of the image tiles based on information of pixel data including vertices of each of the image tiles or information about the position where they are stored. For another example, the second processor 300 may manage the boundary information of the image tiles by generating metadata of the image tiles. In some embodiments, the second processor 300 may write the image tiles into the cache buffer 130 based on an arbitrary data structure. In some embodiments, the second processor 300 may manage the boundary of the image tiles by dividing (logically or physically) the space in which each of the image tiles is written into the cache buffer 130. In some embodiments, the second processor 300 may send the image tiles into the cache buffer 130 such that an image data format is generated.

In some embodiments, boundary information of the image tiles of the image data generated by the second processor 300 may be shared with the first processor 110. For example, the second processor 300 may store boundary information of image tiles in the cache buffer 130, and the first processor 110 (e.g., a main processor) may access the boundary information of image tiles and may perform various processing based on this. In FIG. 12, the second processor 300 loads converted image tiles from the cache buffer 130 and writes the generated image tiles into the cache buffer 130, but the scope of the present disclosure is not limited thereto. It should be understood that an embodiment in which the second processor 300 loads the converted image tiles from the cache buffer 130 or the host memory 220 of FIG. 2 and sends the generated image tiles to the cache buffer 130 or the host memory 220 is also within the scope of the present disclosure.

FIG. 12 is described based on that the second processor 120 generates image tiles from the converted image tiles, but the scope of the present disclosure is not limited thereto. Referring also to FIG. 2, it should be understood that an embodiment in which the storage device 210 (e.g., a storage controller of the storage device 210), the host memory 220 (e.g., a memory controller of the host memory 220), etc. generates image tiles from the converted image tiles based on operation(s) identical to or similar to the operation(s) of FIG. 12 is also within the scope of the present disclosure.

FIG. 13 is a block diagram illustrating a system-on-chip, according to an embodiment of the present disclosure. Referring to FIG. 13, a system-on-chip 400 may include a main processor 410, a first processor 420, a second processor 430, and a cache buffer 440. In some embodiments, the system-on-chip 100 may be included in an electronic device. For example, the system-on-chip 400 may be included in various electronic devices such as a personal computer (PC), a tablet PC, a smartphone, a server, a datacenter, an IoT device (internet of things device), an automotive system, or a wearable device. In some embodiments, the system-on-chip 400 may control the electronic device or may perform operations necessary for the operation of the electronic device. An example of the system-on-chip 400 according to an embodiment of the present disclosure is described through FIG. 13.

The processors 410, 420, and 430 may control the operation of the system-on-chip 400 or perform computational operations. The main processor 410 may be identical to or similar to the first processor 110 of FIGS. 1 to 12, or may operate identically to or similarly to the first processor 110. The first processor 420 and the second processor 430 may be identical to or similar to the second processors 120 and 300 of FIGS. 1 to 12, or may operate identically to or similarly to the second processors 120 and 300. In some embodiments, the processors 410, 420, and 430 may each include a bus interface, similar to the processors 110 and 120 of FIG. 1.

In some embodiments, the processors 410, 420, and 430 may be various processing units or may include various processing units. For example, each of the processors 410, 420, and 430 may be or include a single-core or multi-core CPU, a GPU, an NPU, a TPU, an NP, or a combination thereof. For a more detailed example, the main processor 410 may be a general-purpose processor such as a CPU, and the first processor 420 or the second processor 430 may be a special-purpose processor such as a GPU or an NPU.

In some embodiments, the processors 410, 420, and 430 may include a local cache. In some embodiments, the processors 410, 420, and 430 may include registers that may temporarily store data or instructions necessary for an operation. For example, each of the processors 410, 420, and 430 may include local caches or registers that store instructions indicating an operation to be performed or data necessary for an operation. In some embodiments, the local cache may be or include a volatile memory device such as a static random access memory (SRAM).

In some embodiments, the main processor 410 may control the overall operation of the system-on-chip 400, may schedule operations to be performed by the system-on-chip 400, may determine which entities (e.g., processors 410, 420, and 430) are to perform operations, and may distribute the operations. For example, the main processor 410 may be a general-purpose processor such as a CPU that performs the operations described above.

In some embodiments, the first processor 420 and the second processor 430 may perform specialized operations. In some embodiments, the first processor 420 and the second processor 430 may be special-purpose processors or specialized processors. For example, the first processor 420 and the second processor 430 may be processors specialized in image processing, machine learning, graphic operations, etc. In some embodiments, the first processor 420 and the second processor 430 may operate under the control of the main processor 410.

The first processor 420 and the second processor 430 may provide the kernel processing KP or the data conversion DC described through FIGS. 1 to 12. In some embodiments, the first processor 420 and the second processor 430 may separately perform the data conversion DC and the kernel processing KP. For example, the first processor 420 may generate converted image tiles with respect to image tiles of image data, and the second processor 430 may perform the kernel processing of the image tiles based on the converted image tiles. In this case, the converted image tiles may be stored in the cache buffer 440 and may be accessed by the first processor 420 and the second processor 430.

The cache buffer 440 may store data necessary for the operation of the system-on-chip 400. The cache buffer 440 may be identical to or similar to the cache buffer 130 of FIGS. 1 to 12, or may operate identically to or similarly to the cache buffer 130 of FIGS. 1 to 12. In some embodiments, the cache buffer 440 may store instructions indicating operations of the system-on-chip 400 or data used for the operations of the system-on-chip 400. For example, the cache buffer 440 may store instructions indicating the operations to be performed by the processors 410, 420, and 430. For example, the cache buffer 440 may store data required for the operations of the processors 410, 420, and 430.

In some embodiments, the cache buffer 440 may operate as a global cache of the system-on-chip 400. That is, the cache buffer 440 may have a hierarchical structure with the local caches within the processors 410, 420, and 430 and may be accessed by all of the processors 410, 420, and 430. In some embodiments, the cache buffer 440 may be a volatile memory device such as an SRAM or may include a volatile memory device. The cache buffer 440 may send data or receive data to be stored through a bus 450.

The bus 450 may provide communication within the system-on-chip 400. The bus 450 may be identical to or similar to the bus 140 of FIGS. 1 to 12, or may operate identically to or similarly to the bus 140. In some embodiments, the bus 450 may provide communication among the main processor 410, the first processor 420, the second processor 430, and the cache buffer 440. In some embodiments, the bus 450 may provide communication between components within the system-on-chip 400 based on one of various standards or conventions.

The components included in the system-on-chip 400 illustrated in FIG. 13 are an example and may further include additional components. For example, the system-on-chip 400 may further include an interface for exchanging data with a solid state drive (SSD) device included in an electronic device including the system-on-chip 400 or a host memory (e.g., a DRAM device, etc.) of the electronic device. For another example, the system-on-chip 400 may further include an interface for connecting with one or more devices that receive input from a user or send output to a user. It should also be understood that embodiments in which the system-on-chip 400 does not include at least some of the blocks are also within the scope of the present disclosure. It should also be understood that embodiments in which the bus 450 includes the cache buffer 440 (e.g., embodiments in which the cache buffer 440 and the bus 450 are implemented as a single network-on-chip (NOC)) are also within the scope of the present disclosure.

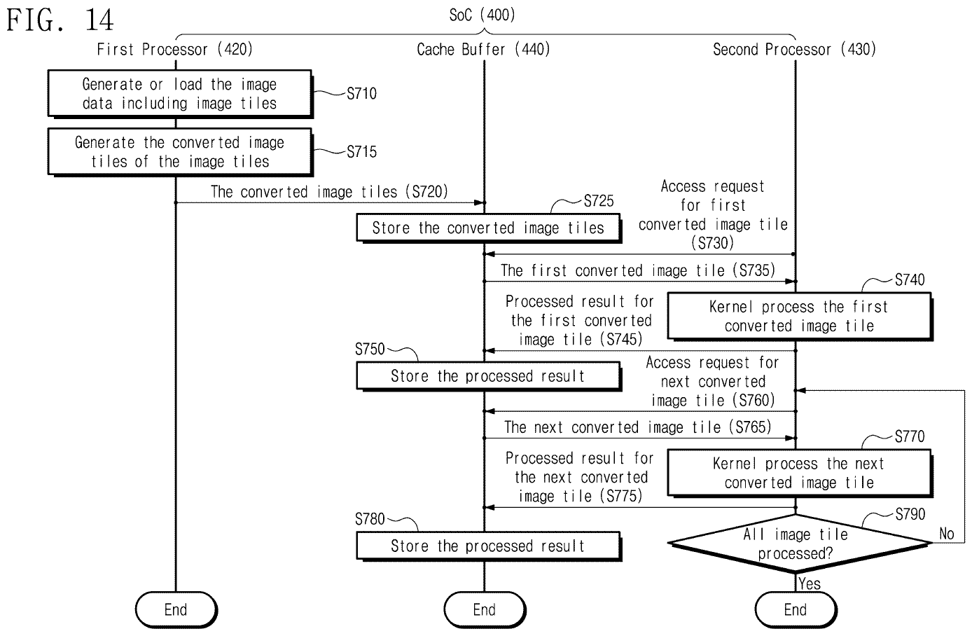

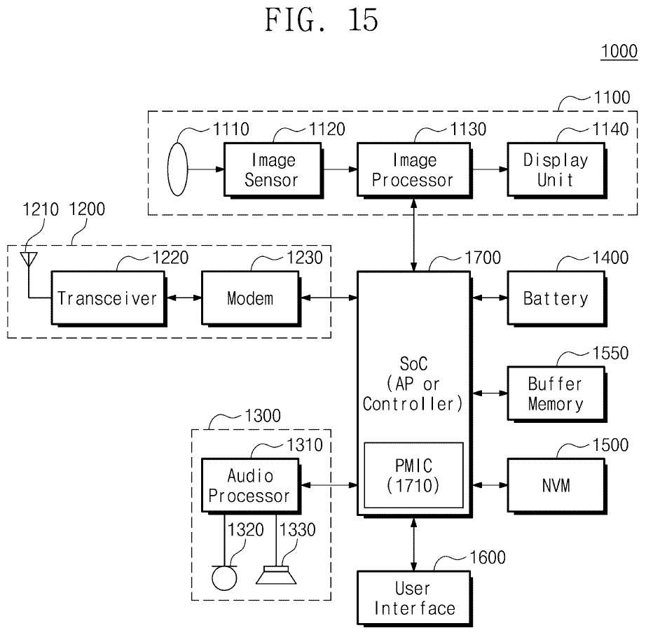

FIG. 14 is a flowchart illustrating an example of an operation method of a system-on-chip of FIG. 13, according to an embodiment of the present disclosure. The data conversion operation and the kernel processing operation of image data of the system-on-chip 400, according to an embodiment of the present disclosure are described through FIGS. 1 to 14. In FIG. 14, the operation of the system-on-chip 400 is described based on that the first processor 420 performs the role of a data producer and the second processor 430 performs the role of a data consumer, but this is an example and the scope of the present disclosure is not limited thereto.

In operation S710, the first processor 420 may generate image data including image tiles or load the image data into the first processor 420. For example, the first processor 420 may load image tiles from the host memory 220 of FIG. 2 into a buffer (e.g., the cache buffer 440). In operation S715, the first processor 420 may generate converted image tiles. In some embodiments, the first processor 420 may generate a converted image tile including pixel data (of adjacent image tiles) and image tiles required for the kernel processing KP of the image tile. In operation S720, the first processor 420 may send the generated converted image tiles to the cache buffer 440.

The first processor 420 may perform operation S710, operation S715, or operation S720 based on operations identical to or similar to those described through FIGS. 5 to 11. In some embodiments, the first processor 420 may perform at least some of operation S710, operation S715, and operation S720 in an overlapping manner. In some embodiments, the first processor 420 may repeat operation S710, operation S715, or operation S720 until the converted image tiles of all image tiles of the image data are generated.

In operation S725, the cache buffer 440 may store the received converted image tile(s). In some embodiments, in operation S725, the cache buffer 440 may store the converted image tiles such that the boundaries between the converted image tiles are (logically or physically) distinguishable. The cache buffer 440 may store the converted image tiles based on operations identical to or similar to the operations described through FIGS. 5 to 11. In some embodiments, when the cache buffer 440 stores all the converted image tiles, the cache buffer 440 may send a response indicating that the converted image tiles are stored to some or all of the processors 410, 420, and 430.

In operation S730, the second processor 430 may send an access request with respect to the first converted image tile to the cache buffer 440. In operation S735, the cache buffer 440 may send the requested first converted image tile to the second processor 430.

In operation S740, the second processor 430 may perform the kernel processing KP on the first converted image tile. In some embodiments, the second processor 430 may perform the kernel processing KP (for example, without cache miss) of the first image tile included in the first converted image tile and corresponding to the first converted image tile based on the kernel processing KP with respect to the first converted image tile. In operation S745, the second processor 430 may send the result of the kernel processing KP on the first converted image tile to the cache buffer 440. In operation S750, the cache buffer 440 may store the received processing result. In some embodiments, the cache buffer 440 may store the processing result and then send a response indicating completion of the storage to the second processor 430.

In some embodiments, the second processor 430 and the cache buffer 440 may perform at least some of operations S740, S745, or S750 in an overlapping manner. In some embodiments, the second processor 430 and the cache buffer 440 may repeat operation S740, operation S745, or operation S750 until the kernel processing KP is performed on all pixel data of an image tile.

The second processor 430 may generate a result of the kernel processing KP on all pixel data of one image tile based on operation S740 or operation S745. In some embodiments, the second processor 430 and the cache buffer 440 may generate and store a result of the kernel processing KP including processed pixel data of the same array as the image tile based on operation S740, operation S745, or operation S750. In some embodiments, the processing result (generated through operation S740 or operation S745) stored in the cache buffer 440 may be accessed by the first processor 420 and may be converted into a conversion processing result, similar to the conversion of an image tile into a converted image tile.

In operation S760, the second processor 430 may send an access request with respect to a next converted image tile to the cache buffer 440. In operation S765, the cache buffer 440 may send the requested next converted image tile to the second processor 430. The second processor 430 may perform operation S760 or operation S765 in a manner identical to or similar to operation S730 or operation S735, respectively.

In operation S770, the second processor 430 may perform the kernel processing KP on the next converted image tile. In some embodiments, the second processor 430 may perform (e.g., without the cache miss) the kernel processing KP of the next image tile included in the next converted image tile and corresponding to the next converted image tile based on the kernel processing KP with respect to the next converted image tile. In operation S775, the second processor 430 may send a result of the kernel processing KP with respect to the next converted image tile to the cache buffer 440. In operation S780, the cache buffer 440 may store the received processing result. In some embodiments, the cache buffer 440 may store the processing result and then may send a response indicating completion of the storage to the second processor 430. The second processor 430 and the cache buffer 440 may perform operations S770 and S780 in the same or similar manner as operations S740 and S750.

In operation S790, the second processor 430 may determine the next operation based on whether the kernel processing is performed on all image tiles. When the kernel processing for all image tiles is completed, the second processor 430 may end the operation. When the kernel processing for all image tiles is not completed, the second processor 430 may return to operation S760.

In FIG. 14, the description is based on that the second processor 430 stores the processing result in the cache buffer 440, but the scope of the present disclosure is not limited thereto. It should also be understood that an embodiment in which the second processor 430 sends the processing result to the host memory 220 of FIG. 2 is also within the scope of the present disclosure.

FIG. 14 illustrates that the second processor 430 generates a processing result including pixel data of the same arrangement as the image tile, but the scope of the present disclosure is not limited thereto. For example, the first processor 420 (or the second processor) may access the processing result in the cache buffer 440 and may generate the conversion processing result (based on an operation identical to or similar to the operation of converting the image tile to the converted image tile).

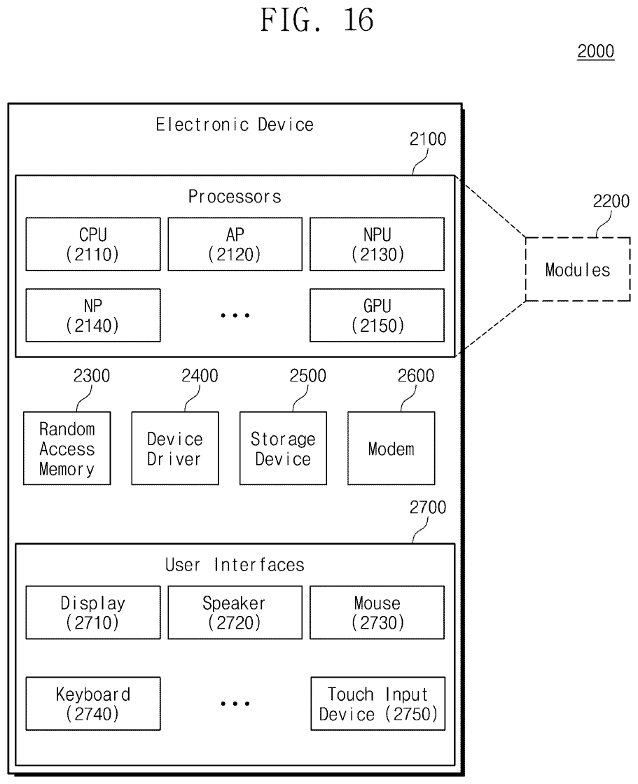

FIG. 15 is a block diagram illustrating an electronic device 1000, according to an embodiment of the present disclosure. Referring to FIG. 15, the electronic device 1000 according to an embodiment of the present disclosure includes an image processing unit 1100, a wireless transceiver unit 1200, an audio processing unit 1300, a battery 1400, a non-volatile memory device 1500, a buffer memory device 1550, a user interface 1600, and an SoC 1700. In some embodiments, the electronic device 1000 may operate under the control of the SoC 1700.

The image processing unit 1100 includes a lens 1110, an image sensor 1120, an image processor 1130, and a display unit 1140. The image processor 1130 may convert an image of reality into image data through the lens 1110 and the image sensor 1120. The display unit 1140 may display an image data signal generated by the image processor 1130 or image data to be provided to a user. The display unit 1140 may be formed of an LCD (Liquid Crystal Display) or an OLED (Organic Light Emitting Diodes). When the LCD or the OLED is implemented in a touch screen manner, the display unit 1140 may also operate together with the user interface 1600.

The wireless transceiver unit 1200 includes an antenna 1210, a transceiver 1220, and a modulator/demodulator (MODEM) 1230. The wireless transceiver unit 1200 may perform a wireless communication function. The transceiver 1220 may adjust the frequency of a signal transmitted through the antenna 1210 or amplify the transmitted signal, and may adjust the frequency of a signal received through the antenna 1210 or amplify the received signal. The MODEM 1230 may include a transmitter that encodes and modulates a signal to be transmitted and a receiver that demodulates and decodes a signal received through the antenna 1210. The antenna 1210 and the MODEM 1230 of the wireless transceiver unit 1200 may process signals exchanged with an external device/system according to at least one of various wireless communication protocols, such as LTE (Long Term Evolution), WiMax (Worldwide Interoperability for Microwave Access), GSM (Global System for Mobile communication), CDMA (Code Division Multiple Access), Bluetooth, NFC (Near Field Communication), Wi-Fi (Wireless Fidelity), RIDD (Radio Frequency Identification), etc.

The audio processing unit 1300 includes an audio processor 1310, a microphone 1320, and a speaker 1330. The audio processing unit 1300 may configure a codec, and the codec may include a data codec and an audio codec. The data codec may process packet data, etc., and the audio codec may process audio signals such as voice and multimedia files. In addition, the audio processing unit 1300 may perform a function of converting a digital audio signal received from the MODEM 1230 into an analog signal through the audio codec to be played back, or may perform a function of converting an analog audio signal generated from the microphone 1320 into a digital audio signal through the audio codec to be transmitted to the MODEM 1230. The codec may be provided separately or included in the SoC 1700.

The battery 1400 may provide a power source required for the operation of the electronic device 1000. In FIG. 15, the electronic device 1000 is illustrated as being powered by the battery 1400, but it should be understood that an embodiment in which an external power source or an external power source acts as the battery 1400 is also within the scope of the present disclosure.

The non-volatile memory device 1500 may store data of the electronic device 1000. For example, the non-volatile memory device 1500 may be a NAND flash memory device or may include the NAND flash memory device. The non-volatile memory device 1500 may be provided as a memory card (an MMC, an eMMC, a SD, a micro SD), etc., according to an embodiment of the present disclosure. The non-volatile memory device 1500 may be identical to or similar to the storage device 210 of FIGS. 2 to 14, or may operate identically or similarly to the operation of the storage device 210 of FIGS. 2 to 14.

The buffer memory device 1550 may store data used for the operation of the SoC 1700 or data generated by the operation. In some embodiments, the buffer memory device 1550 may load a portion of the data of the non-volatile memory device 1500 to be provided to the SoC 1700. In some embodiments, the buffer memory device 1550 may be a volatile memory device (such as a DRAM or an SRAM) or may include the volatile memory device. The buffer memory device 1550 may be the same as or similar to the host memory 220 of FIGS. 2 to 14 and may operate the same as or similar to the operation of the host memory 220.

The user interface 1600 may receive input from the outside or provide output to the outside. For example, the user interface 1600 may receive input through a device such as a keyboard or a mouse. In some embodiments, the user interface 1600 may include a driver for receiving input from devices. In some embodiments, the user interface 1600 may operate with the display unit 1140 or the audio processing unit 1300 to generate output.

The SoC 1700 may drive an application program, an operating system, etc. In some embodiments, the SoC 1700 may include a processor, such as a general-purpose processor or a special-purpose processor. In some embodiments, the SoC 1700 may control the components of the electronic device 1000. The SoC 1700 may include a PMIC 1710. The PMIC 1710 may receive voltage from the battery 1400 and may convert a level of the received voltage. The PMIC 1710 may provide the converted voltage level to each component of the electronic device 1000. In some embodiments, the SoC 1700 may correspond to the system-on-chip 100 or 400 of FIGS. 1 to 14, or may be identical or similar to the system-on-chip 100 or 400 of FIGS. 1 to 14.

The configurations of the electronic device 1000 illustrated in FIG. 15 are an example and the scope of the present disclosure is not limited thereto. For example, the electronic device 1000 may further include a volatile memory device as a system memory, and the volatile memory device may operate in response to the control of the SoC 1700. In some embodiments, the electronic device 1000 may not include some of the components of FIG. 15. For example, the electronic device 1000 may not include the image processing unit 1100.

FIG. 16 is a block diagram illustrating an electronic device 2000, according to an embodiment of the present disclosure. Referring to FIG. 16, the electronic device 2000 may include processors 2100, a random access memory 2300, a device driver 2400, a storage device 2500, a MODEM 2600, and user interfaces 2700.

The processors 2100 may include at least one general-purpose processor, such as, for example, a central processing unit (CPU) 2110, an application processor (AP) 2120, etc. The processors 2100 may also include at least one special purpose processor, such as a neural processing unit 2130, a neuromorphic processor 2140, a graphics processing unit (GPU) 2150, etc. The processors 2100 may include two or more of the same type of processors or may not include at least some of the processors described above.

In some embodiments, the central processing unit 2110 may correspond to the first processor 110 of FIGS. 1 to 12 or the main processor 410 of FIGS. 13 and 14. In some embodiments, at least some of the special purpose processors 2130, 2140, and 2150 may correspond to the second processor 120 of FIGS. 1 to 12 or the first processor 420 or the second processor 430 of FIGS. 13 and 14.

At least one of the processors 2100 may execute modules 2200. For example, at least some of the modules 2200 may be modules that are trained based on machine learning or deep learning, and at least other some of the modules 2200 may be modules that operate based on a predetermined algorithm. In some embodiments, the modules 2200 may be modules that perform image processing.

At least one of the processors 2100 may be used to train modules 2200 (e.g., some of the modules 2200 that are related to learning) or to execute the trained modules 2200. At least one of the processors 2100 may train or execute modules 2200 based on various data or information. For example, the modules 2200 may be implemented in the form of instructions (or codes) that are executed by at least one of the processors 2100. In this case, at least one processor may load instructions (or codes) of the modules 2200 into the random access memory 2300.

As another example, at least one (or at least the other) processor of the processors 2100 may be manufactured to implement the modules 2200. For example, at least one processor may be a dedicated processor implemented in hardware based on the modules 2200 generated by training the modules 2200.

As another example, at least one (or at least the other) of the processors 2100 may be manufactured to implement various machine learning modules or various deep learning modules. The at least one processor may implement the modules 2200 by receiving information (e.g., commands or codes) corresponding to the modules 2200.

The random access memory 2300 may be used as a working memory of the processors 2100 and may be used as a main memory or a system memory of the electronic device 2000. The random access memory 2300 may include a volatile memory such as a dynamic random access memory or a static random access memory or a nonvolatile memory such as a phase-change random access memory, a ferroelectric random access memory, a magnetic random access memory, or a resistive random access memory. In some embodiments, the random access memory 2300 may include the cache buffer of FIGS. 1 to 14 or may provide the function of a cache buffer.

The device driver 2400 may control the following peripheral devices depending on a request of the processors 2100: the storage device 2500, the MODEM 2600, and the user interfaces 270. The storage device 2500 may include a stationary storage device such as a hard disk drive or a solid state drive, or a removable storage device such as an external hard disk drive, an external solid state drive, or a removable memory card.

The MODEM 2600 may provide remote communication with an external device. The MODEM 2600 may perform wired or wireless communication with the external device. The MODEM 2600 may communicate with the external device based on at least one of various communication schemes such as Ethernet, wireless-fidelity (Wi-Fi), long term evolution (LTE), and 5th generation (5G) mobile communication.

The user interfaces 2700 may receive information from a user and may provide information to the user. The user interfaces 2700 may include at least one user output interface such as a display 2710 or a speaker 2720, and at least one user input interface such as a mouse 2730, a keyboard 2740, or a touch input device 2750.

Commands (or codes) of the modules 2200 may be received through the MODEM 2600 and stored in the storage device 2500. The commands (or codes) of the modules 2200 may be stored in a removable storage device and coupled to the electronic device 2000. The commands (or codes) of the modules 2200 may be loaded from the storage device 2500 into the random access memory 2300 and may be executed.

According to an embodiment of the present disclosure, a data storage method or a data conversion method of a processor is provided, which enables the processor performing kernel processing to reduce a cache miss ratio and to perform efficient kernel processing or kernel operations.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A method of operating a system-on-chip, comprising:
generating a first converted image tile corresponding to a first image tile, based on the first image tile and a second image tile disposed adjacent to the first image tile, the first image tile and the second image tile selected from a plurality of image tiles included in image data, wherein:
the first image tile includes a plurality of first pixel data;
the second image tile includes a plurality of second pixel data; and
the first converted image tile includes the plurality of first pixel data and at least one second adjacent pixel data disposed adjacent to the first image tile, the at least one second adjacent pixel data selected from the plurality of second pixel data;
generating a second converted image tile corresponding to the second image tile, based on the first image tile and the second image tile, wherein the second converted image tile includes the plurality of second pixel data and at least one first adjacent pixel data disposed adjacent to the second image tile, the at least one first adjacent pixel data selected from the plurality of first pixel data;
storing the first converted image tile in a memory hierarchy, wherein the memory hierarchy includes a local cache, a system cache, a host memory, and a storage device;
storing the second converted image tile in the memory hierarchy; and
performing kernel processing based on the first converted image tile and the second converted image tile.

2. The method of claim 1, wherein:
the at least one first adjacent pixel data forms one column of the plurality of first pixel data; and
the at least one second adjacent pixel data forms one column of the plurality of second pixel data.

3. The method of claim 1, wherein:
a right boundary of the first converted image tile includes leftmost pixel data of the second image tile, and
a left boundary of the second converted image tile includes rightmost pixel data of the first image tile.

4. The method of claim 1, wherein:
the plurality of first pixel data are arranged in “m” rows and “n” columns;
the plurality of second pixel data are arranged in “m” rows and “n” columns; and
“m” and “n” are natural numbers.

5. The method of claim 4, wherein generating the first converted image tile includes:
loading a first row of the first image tile and a first row of the second image tile;
sending the first row of the first image tile to the system cache;
loading the at least one second adjacent pixel data; and
sending the at least one second adjacent pixel data to the system cache.

6. The method of claim 5, wherein generating the second converted image tile includes:
sending the at least one first adjacent pixel data to the system cache; and
sending the first row of the second image tile to the system cache.

7. The method of claim 6, further comprising:
loading a third image tile adjacent to the first image tile and positioned in a diagonal direction from the second image tile; and
loading a fourth image tile adjacent to the second image tile and the third image tile and positioned in a diagonal direction from the first image tile.

8. The method of claim 7, wherein:
the first converted image tile and the second converted image tile include “k” rows; and
generating the first converted image tile and the second converted image tile includes:
generating (k-1) rows of each of the first converted image tile and the second converted image tile to be sent to the system cache;
generating a second row of a third converted image tile corresponding to the third image tile and a second row of a fourth converted image tile corresponding to the fourth image tile; and
sending the second row of the third converted image tile and the second row of the fourth converted image tile to the system cache, where “k” is a natural number greater than or equal to 2.

9. The method of claim 8, wherein:
the third converted image tile includes one column adjacent to the third image tile from the fourth image tile; and
the fourth converted image tile includes one column adjacent to the fourth image tile from the third image tile.

10. The method of claim 8, wherein:
the second row of the third converted image tile includes a first row of the third image tile;
the second row of the fourth converted image tile includes a second row of the fourth image tile; and
generating the third converted image tile and the fourth converted image tile includes:
sending a k-th row of the first converted image tile and the second converted image tile to the system cache; and
sending the second row of the third converted image tile and the fourth converted image tile to the system cache.

11. A processor configured for kernel processing and data conversion of image tiles, the processor comprising:
a processing block configured to:
perform the kernel processing; and
control the processor;
a data conversion block configured to control the data conversion and an input/output of the processor; and
a bus interface block configured to perform the input/output of the processor,
wherein:
the image tiles comprise a first image tile including a plurality of first pixel data and a second image tile disposed adjacent to the first image tile and including a plurality of second pixel data;
the processor is configured to perform the data conversion to generate a first converted image tile corresponding to the first image tile and a second converted image tile corresponding to the second image tile, wherein the first converted image tile includes the plurality of first pixel data and at least one second adjacent pixel data disposed adjacent to the first image tile, the at least one second adjacent pixel data selected from the plurality of second pixel data, and
the second converted image tile includes the plurality of second pixel data and at least one first adjacent pixel data disposed adjacent to the second image tile, the at least one first adjacent pixel data selected from the plurality of first pixel data.

12. The processor of claim 11, wherein:
the first converted image tile further includes one or more pixel data of an adjacent image tile used for the kernel processing of the first image tile; and
the second converted image tile further includes one or more pixel data of an adjacent image tile used for the kernel processing of the second image tile.

13. The processor of claim 11, further comprising:
a function register block configured to store information about a size of a kernel in the kernel processing and a size of the image tiles.

14. The processor of claim 13, wherein the bus interface block is further configured to:
send a first row of the first image tile to a system cache;
load the at least one second adjacent pixel data; and
send the at least one second adjacent pixel data to the system cache to generate one row of the first converted image tile.

15. The processor of claim 14, wherein the bus interface block is further configured to:
send the pixel data of the first image tile and the at least one second adjacent pixel data to the system cache; and
send the first row of the second image tile to the system cache to generate one row of the second converted image tile.

16. The processor of claim 13, further comprising:
a local cache block configured to:
store data for kernel processing by the processor; and
load one converted image tile on which the kernel processing is performed.

17. A system-on-chip, comprising:
a main processor configured to control an operation of the system-on-chip;
a first processor configured to perform kernel processing and data conversion of image tiles; and
a system cache configured to store data of the system-on-chip,
wherein:
the image tiles include a first image tile and a second image tile disposed adjacent to the first image tile,
the first processor is configured to generate a plurality of converted image tiles including a first converted image tile corresponding to the first image tile and a second converted image tile corresponding to the second image tile,
the first converted image tile includes a plurality of first pixel data and at least one second adjacent pixel data disposed adjacent to the first image tile, the at least one second adjacent pixel data selected from a plurality of second pixel data; and
the second converted image tile includes the second plurality of pixel data and at least one first adjacent pixel data disposed adjacent to the second image tile, the at least one first adjacent pixel data selected from the plurality of first pixel data.

18. The system-on-chip of claim 17, further comprising:
a second processor configured to perform kernel processing and data conversion of the image tiles,
wherein
the first processor is further configured to store the converted image tiles in the system cache, and
the second processor is further configured to load one of the converted image tiles to perform the kernel processing.

19. The system-on-chip of claim 17, wherein:
the first converted image tile further includes one or more pixel data of an adjacent image tile used for the kernel processing of the first image tile; and
the second converted image tile further includes one or more pixel data of an adjacent image tile used for the kernel processing of the second image tile.

20. The system-on-chip of claim 19, wherein the first processor is further configured to:
send a first row of the first image tile to the system cache;
load the at least one second adjacent pixel data; and
send the at least one second adjacent pixel data to the system cache to generate one row of the first converted image tile.
